(19) United States
(12) Patent Application Publication
(10) Pub. No.: US 2004/0006529 A1
(43) Pub. Date: Jan. 8, 2004

(54) Method and system for utilizing a special purpose vehicle for improving the liquidity of transactions

(76) Inventor: Ka Shun Kevin Fung, Hong Kong (HK)

Correspondence Address: SAWYER LAW GROUP LLP, P.O. Box 51418, Palo Alto, CA, 94303, US

(21) Appl. No.: 10/601,173

(22) Filed: Jun. 19, 2003

Related U.S. Application Data
(60) Provisional application No. 60/389,956, filed on Jun. 20, 2002.

(51) Int. Cl. G06F 17/60

(52) U.S. Cl. 705/37

(57) ABSTRACT

A method and system for improving liquidity of transactions for a plurality of contracts is disclosed. In one aspect, the method and system include providing a special purpose vehicle for buying and/or selling at least a portion of a complete set including the plurality of contracts. The complete set guarantees at least an initial settlement at at least one particular time. The complete set also corresponds to a settlement value. The settlement value is determined based upon the initial settlement value. In another aspect, the method and system include defining a complete set including the plurality of contracts and allowing at least one market participant to lock in a trade for a portion of the plurality of contracts. The portion of the plurality of contracts includes multiple contracts. The complete set guarantees at least an initial settlement at at least one particular time. The complete set corresponds to a settlement value. The settlement value is determined based upon the initial settlement value.

### CROSS-REFERENCE TO RELATED APPLICATIONS

This application is claiming under 35 USC 119(e) the benefit of provisional patent application serial No. 60/389,956 filed on Jun. 20, 2002.

The present application is related to co-pending U.S. patent application Ser. No. ______ (2626P), entitled “METHOD AND SYSTEM FOR IMPROVING THE LIQUIDITY OF TRANSACTIONS” filed on ______. The present application is also related to co-pending U.S. patent application Ser. No. ______ (2701P), entitled “METHOD AND SYSTEM FOR MANAGING CREDIT-RELATED AND EXCHANGE RELATED RISKS” filed on ______.

### FIELD OF THE INVENTION

The present invention relates to financial instruments, and more particularly to a method and system for improving the liquidity of transactions, preferably using a computer system.

### BACKGROUND OF THE INVENTION

A variety of financial instruments, or contracts, are currently traded in many different markets. These contracts could take a variety of forms and be related to a variety of activities. For example, the contracts could range from options and futures to betting. Participants in the markets place bids (offers to buy contract(s)) and offers (offers to sell contract(s)). Each offer and bid has a price associated. The participants in the market could include individual participants, financial intermediaries, or market makers, such as brokerage houses or banks. Furthermore, the buyers and sellers could be short or long. For example, a long seller is a seller already having a position in the market and holding the contract for which the seller made an offer. A short seller is a seller who does not yet have ownership of the contract being offered for short sale. Similarly, a buyer may be making a bid to cover a contract previously offered for sale. In the case of betting, in buying a contract, a buyer may simply be making a bet. Similarly, a seller of a contract in betting is typically a bookmaker. Systems such as www.betfair.com and www.intrade.com allow customers to buy multiple contracts (bets). Thus, relationships between buyers, sellers, individual participants and market makers may be complex. Furthermore, unnecessary uncertainty may be created in these relationships, which indirectly increases trading costs. In addition, the market in which the participants act could be a traditional exchange, a bookmaking enterprise such as a casino, or other similar market.

Typically, the interaction between the market participants can take place via three conventional structures: conventional order matching, conventional market making, and conventional auctions. In conventional order matching, bids and offers are centralized, typically in an exchange. Individual participants can then buy or sell until an equilibrium for a particular contract is reached. Typically, the exchange takes no risk in the market. In conventional market making, a market maker takes a position opposite to other market participants. Thus, a market maker may sell or buy contracts to other market participants. In conventional auctions, a contract is typically offered for sale to any market participant. Conventional auctions can take a variety of forms. In certain conventional auctions, the contract is initially offered at a high price. The price is progressively lowered until a bid is made and the contract is sold. In conventional Dutch auctions, the lowest price necessary to sell the entire lot of contracts becomes the price at which the contracts are sold.

Regardless of the structures used, the market can be viewed as coming to equilibrium when the prices for all bids for a particular contract are less than prices for all offers for the contract. In other words, no bid is high enough (or conversely no offer is low enough) for a transaction to take place and the contract to be sold. As a result, no more transactions will take place for the contract until a new bid and/or new offer that bridge the gap between the bids and offers is made.

Although conventional structures allow transaction to take place and for the market to come to equilibrium, conventional methods for allowing transactions have drawbacks. First, the conventional structures may not result in a high degree of liquidity. Typically, liquidity can be measured in three ways: bid/offer spread, volume and price discovery. The bid/offer spread is an instantaneous measurement of liquidity. The bid/offer spread is the difference between the highest bid and lowest offer for a particular contract at a particular instant in time. The higher the bid offer spread, the lower the liquidity because the less likely that a market participant will be able to sell or buy the contract. The volume can be considered to be the time required to have an order for a contract filled or the volume of transactions for a given unit of time. The lower the time required to fill an order and the higher the volume of transactions, the greater the liquidity and the easier it would be for a market participant to enter or leave the market. Price discovery is the ability to discover the true price of a contract in the market that has reached equilibrium. The easier it is to discover the price of a contract, the higher the liquidity. Thus, conventional structures such as order matching may result in a higher bid/offer spread, a lower volume of transactions, and more difficulty in determining the actual price of the contracts.

A high liquidity is desirable. A higher liquidity allows the market participants to move in and out of the market more easily. In addition, exchanges desire a high liquidity because exchanges typically obtain a profit based upon the number of transactions carried out. The higher the liquidity is, the higher the number of transactions and the greater the profit of the exchange. Market makers desire a higher liquidity because a high liquidity translates to a higher number of transactions, lower risk for the market maker and a lower cost of borrowing capital for the market maker. Thus, it would be desirable for a higher liquidity in the market place than may be available using the conventional structures for performing transactions.

In addition, the conventional structures of conventional order matching, market making and auctions performed in the conventional manner described above have other drawbacks. Conventional order matching often does not function well when there is an insufficient number of sellers that actually have contract(s) to sell, as opposed to a short seller. As a result, there will be lowered liquidity. In some situations, conventional market makers may actually have an incentive to reduce the competitive nature of the marketplace because the market maker may act to their own advantage, rather than to the advantage of the market as a whole. Conventional auctions take time to set up and identify winner(s).

Accordingly, what is needed is a system and method for addressing the drawbacks of conventional mechanism for allowing transaction to occur. The present invention addresses such a need.

### SUMMARY OF THE INVENTION

The present invention provides a method and system for improving liquidity of transactions for a plurality of contracts. In one aspect, the method and system comprise providing a special purpose vehicle for buying and/or selling at least a portion of a complete set including the plurality of contracts. The complete set guarantees at least an initial settlement at at least one particular time. The complete set also corresponds to a settlement value. The settlement value is determined based upon the initial settlement value. In another aspect, the method and system comprise defining a complete set including the plurality of contracts and allowing at least one market participant to lock in a trade for a portion of the plurality of contracts. The portion of the plurality of contracts includes multiple contracts. The complete set guarantees at least an initial settlement at at least one particular time, the complete set corresponds to a settlement value, which is determined based upon the initial settlement value.

According to the system and method disclosed herein, the present invention provides improved liquidity, improves the management of credit related risks and allows greater flexibility in transactions.

### BRIEF DESCRIPTION OF THE DRAWINGS

FIG. 1A is a high level flow chart depicting one embodiment of a method in accordance with the present invention for improving the liquidity of transactions.

FIG. 1B is a high level flow chart depicting another embodiment of a method in accordance with the present invention for improving the liquidity of transactions.

FIG. 1C is a block diagram of one embodiment of a computer system that can be used for the method in accordance with the present invention.

FIG. 2A is a more detailed flow chart depicting one embodiment of a method in accordance with the present invention for using the special purpose vehicle for buying and selling contracts.

FIG. 2B is a block diagram depicting one embodiment of a special purpose vehicle in accordance with the present invention that interacts with market participants.

FIG. 3A is a more-detailed flow chart depicting one embodiment of a method in accordance with the present invention for using the special purpose vehicle to generate orders and improve the liquidity of transactions.

FIG. 3B is a block diagram depicting one embodiment of a special purpose vehicle in accordance with the present invention that interacts with market participants.

FIG. 4A is a flow chart depicting one embodiment of a method in accordance with the present invention for managing credit related risks utilizing a special purpose vehicle in accordance with the present invention.

FIG. 4B depicts one embodiment of a system in accordance with the present invention when a bank acts as a custodian.

FIGS. 4C-4G depict block diagrams of embodiments of a special purpose vehicle in accordance with the present invention that interact with market participants to manage credit related risks.

FIG. 5A is a flow chart depicting one embodiment of a method in accordance with the present invention for utilizing financial institutions as guarantors of contract sets in accordance with the present invention.

FIGS. 5B-5H depict block diagrams of embodiments of a special purpose vehicle in accordance with the present invention that interact with market participants and financial institutions in transactions.

FIG. 6 is a detailed flow chart of one embodiment of a method in accordance with the present invention for utilizing the special purpose vehicle to provide securities for transactions involving contracts in the complete set.

FIG. 7A depicts a high level flow chart of one embodiment of a method in accordance with the present invention for converting certain financial instruments into a complete set.

FIG. 7B depicts a high level flow chart of one embodiment of a method in accordance with the present invention for converting contract orders into other financial instruments.

FIG. 8 is a high level flow chart of one embodiment of a method in accordance with the present invention for managing risks by matching transactions.

### DETAILED DESCRIPTION OF THE INVENTION

The present invention relates to an improvement in transactions involving financial instruments. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown, but is to be accorded the widest scope consistent with the principles and features described herein.

The present application is related to co-pending U.S. patent application Ser. No. ______ (2626P), entitled “METHOD AND SYSTEM FOR IMPROVING THE LIQUIDITY OF TRANSACTIONS” filed on ______. Applicant hereby incorporates by reference the above-identified co-pending patent application.

Using the method and system described in the above-identified co-pending application, liquidity of transactions is improved. The method and system preferably deals with the kinds of contracts described above. Each contract in the complete set matures upon a particular event or events and might be traded individually. The contracts could be concerning a wide variety of subjects. Such contracts include but are not limited to options, futures, contracts based on PM pools, contracts based on auction orders and bets. In a preferred embodiment, each contract is discrete. A discrete contract is one which, upon maturing, either wins or loses. Thus, the payment a holder of the contract is due upon maturing is either a positive sum (for a winning contract) or zero (for a losing contract). For example, if the contract is a bet on a particular sporting event, upon expiration of the sporting event, a holder of the contract has either won or lost. Thus, the outcome for such a contract can be considered to be a yes/no or true/false type of outcome. However, in another embodiment the payment amount to which the holder of the contract is entitled may vary. For example, one such contract may entitle its holder to be paid a variable amount conditional upon whether the actual price of the stock is higher than a predetermined price level (the strike price of the call option) at a particular time. The particular time can be considered to be the event upon which the contract matures. If, at the particular time, the stock has an actual price that is higher than the strike price, then the contract wins. However, the total amount that the holder is due depends upon the difference between the actual price of the stock and the strike price of the option. Moreover, such variable amount is usually subject to a predetermined “ceiling” (the capped amount for call spread or capped call option).

The method and system described in the above-identified co-pending application define a complete set of contracts including a plurality of contracts. The complete set guarantees at least an initial settlement value at at least one particular time. The complete set also corresponds to a settlement value that is determined based upon the initial settlement value. In a preferred embodiment, the complete set is determined based upon the initial settlement value and an interest rate effect, if necessary. Thus, the settlement value is preferably the initial settlement value with the time value of money accounted for, if desired. Consequently, the complete set can be viewed as fulfilling the condition that the complete set corresponds to a constant total sum (CTS) corresponding to the settlement value. In a preferred embodiment, the contracts in the complete set are not only discrete but also mutually exclusive and collectively exhaustive. Because the contracts are mutually exclusive, if one contract in the complete set is a winning contract, no other contract in the complete set will be a winning contract. Because the contracts are collectively exhaustive, all outcomes are represented by the complete set of contracts. However, the contracts in the complete set need not be mutually exclusive and/or collectively exhaustive. In order to define the complete set, the method and system described in the above-identified co-pending application monitor the marketplace or exchange to determine candidates for the complete set. For example, for stock options, candidates for the complete set might include a put spread and a call spread for a particular stock. If the complete set of contracts is based upon sporting event(s), candidates for the complete set might include the outcome(s) of the sporting events. If the contracts are for a commodity, then candidates for the complete set might include price ranges for the commodity. Based on the candidates found, the complete set can be determined.

The settlement value for the complete set is preferably guaranteed regardless of the price of each contract. In addition, the settlement value is preferably guaranteed regardless of the occurrence of the particular event(s) upon which the contracts' maturing depends. In one embodiment, the complete set can be exchanged for the settlement value at any time. In another embodiment, the settlement value can only be exchanged upon maturity of the contracts (or when the contracts do not mature). Thus, the complete set corresponds to the settlement value regardless of the outcome of the individual contracts or whether a particular contract is deemed to win. Furthermore, because at least the settlement value is preferably guaranteed independent of the occurrence of the event(s) upon which maturation of the contracts depends, the settlement value is preferably guaranteed even in the event that none of the contracts in the complete set is deemed to be a winner. This settlement value is determined and, except for the constant time value of money described below, can be considered to be constant. Thus, the complete set of contracts can be considered to be equivalent to CTS known as the settlement value. The settlement value can be determined in a variety of ways, typically based upon the price level of the underlying variable that characterizes the possible outcome(s) of the contracts in the complete set at the time the complete set is defined. Thus, the market conditions are preferably considered in determining the settlement value. In one embodiment, the settlement value is related to the tick value of the underlying variable. For example, if the complete set of contracts relates to the price of a commodity, such as gold, the price level is preferably based upon the price of gold and, preferably, the tick value of the gold (or an integral multiple of tick value). In a preferred embodiment, the settlement value may be adjusted to account for an interest rate effect, and ensure that the time value of the settlement value is constant. Stated differently, an adjustment in present value may be made to ensure that the “time value” of the settlement value remains constant over time. Consequently, where the settlement value is in money, such as money paid by buyer(s) in transaction(s) occurring in a typical stock exchange that is non-interest-bearing to the buyer(s) concerned, (as opposed to another instrument having a value that automatically adjusts for the interest rate, such as money paid by buyers in transactions occurred in a typical futures exchange that is interest-bearing to buyers concerned), the settlement value is adjusted. In a preferred embodiment, the settlement value is adjusted based upon the initial settlement value determined at the time the complete set is defined. This initial settlement value is realized at a predetermined time, typically when the contract(s) mature due to the occurrence of the corresponding event(s). The settlement value is determined based upon the initial settlement value, the time between the exchange of the complete set and the predetermined time at which the initial settlement value would be realized, and the interest rate (which might vary) over that time period. In other words, the settlement value at a particular time can be considered to be the initial settlement value discounted to the particular time. In such a case, monies under custody are preferably deposited in an interest bearing account in order to ensure the constant time value of the settlement value.

Each contract in the complete set preferably matures upon the same event(s) occurring. However, nothing prevents the contracts from maturing upon different events. The contracts in the complete set may relate to a particular range of a variable. In such a case, the winning contract(s) at the boundaries between ranges are determined when the complete set is defined. For example, each contract may be for a return if the price of a particular stock is within a range. In some complete sets, only one winner would exist at a boundary. In other complete sets, multiple contracts could be determined to be the winner at the boundary, with the winnings split in a particular fashion. In addition, in a preferred embodiment, the initial settlement value corresponds to the contracts in the complete set maturing. However, nothing prevents the at least one particular time and, therefore, the initial settlement value from corresponding to other times.

In the method and system described in the above-identified co-pending application, the complete set preferably corresponds to the settlement value regardless of whether the particular event(s) occur for any of the plurality of contracts and regardless of the price for each of the contracts in the complete set. Preferably, market participant(s) are also allowed to obtain the complete set of contracts in exchange for the settlement value and/or the initial settlement value. Consequently, the condition required to be met in order to obtain the settlement value is that the market participant(s) hold (or short) the complete set. Although a single market participant can hold/short the complete set, in a preferred embodiment multiple market participants can form a group. As long as the group holds the complete set, the group can exchange the complete set for the settlement value. The settlement value could be provided in cash. However, in alternate embodiments, cash need not be used. For example, the settlement value can be paid in goods or a negotiable instrument particular to the exchange in which the transaction is made. Payment in such a negotiable instrument would secure greater loyalty of the market participant to the exchange because the settlement value could only be used in transactions in the exchange. In addition, profits for the exchange could improve because of the increased number of transactions.

Using the method and system described in the above-identified co-pending application, liquidity can be improved beyond the equilibrium established using conventional mechanisms. For example, equilibrium may be established in a conventional manner. As a result, all bids would be less than all offers for the contracts in a complete set. However, the sum of the bids for the contracts in the complete set may be greater than the settlement value. In such a case, a market participant or other entity may obtain the complete set in exchange for the settlement value. The contracts in the complete set could then be sold individually to each bidder to obtain a profit. Similarly, if the sum of the offers for the contracts in a complete set is less than the settlement value, then a market participant or other entity would use the offers to individually buy the contracts. The complete set could then be exchanged for the settlement value and a profit obtained. As a result, more transactions would take place. Liquidity is, therefore, improved.

The method and system described in the above-identified co-pending application can also be extended to provide additional benefits, particularly using a special purpose vehicle (SPV), which is also at least partially described in the above-identified co-pending patent application. The SPV described in the above-identified co-pending patent application performs a variety of functions. The SPV can buy and sell one or more of the contracts in the complete set, including the complete set itself. The functions of the SPV can be extended to provide further benefits.

The present invention provides a method and system for improving liquidity of transactions for a plurality of contracts. In one aspect, the method and system comprise providing a special purpose vehicle for buying and/or selling at least a portion of a complete set including the plurality of contracts. The complete set guarantees at least an initial settlement at at least one particular time. The complete set also corresponds to a settlement value. The settlement value is determined based upon the initial settlement value. In a preferred embodiment, the settlement value is determined based upon the initial settlement value and an interest rate effect, if necessary. In another aspect, the method and system comprise defining a complete set including the plurality of contracts and allowing at least one market participant to lock in a trade for a portion of the plurality of contracts. The portion of the plurality of contracts includes multiple contracts. The complete set guarantees at least an initial settlement at at least one particular time, the complete set corresponds to a settlement value, which is determined based upon the initial settlement value and an interest rate effect, if any.

The present invention will be described in terms of a particular financial instruments and particular markets or exchanges. However, one of ordinary skill in the art will readily recognize that this method and system will operate effectively for other financial instruments and other market places. The present invention is also described in terms of particular components having certain features. However, one of ordinary skill in the art will readily recognize that the present invention is consistent with additional components and/or different or additional features. Furthermore, the present invention is described in the context of a single special purpose vehicle interacting with individual market participants. However, one of ordinary skill in the art will readily recognize that the method and system are consistent with multiple special purpose vehicles and/or multiple market participants. Further, for clarity the present invention is described using various examples. One of ordinary skill in the art will recognize that the present invention is consistent with different numbers and types of customers, contracts, bids, offers or other situations not illustrated in examples. Thus, one of ordinary skill in the art will readily recognize that the method and system in accordance with the present invention are not limited to such examples. For example, for clarity, dollars are often used in the examples herein. However, one of ordinary skill in the art will readily recognize that the method and system are not limited to a single currency.

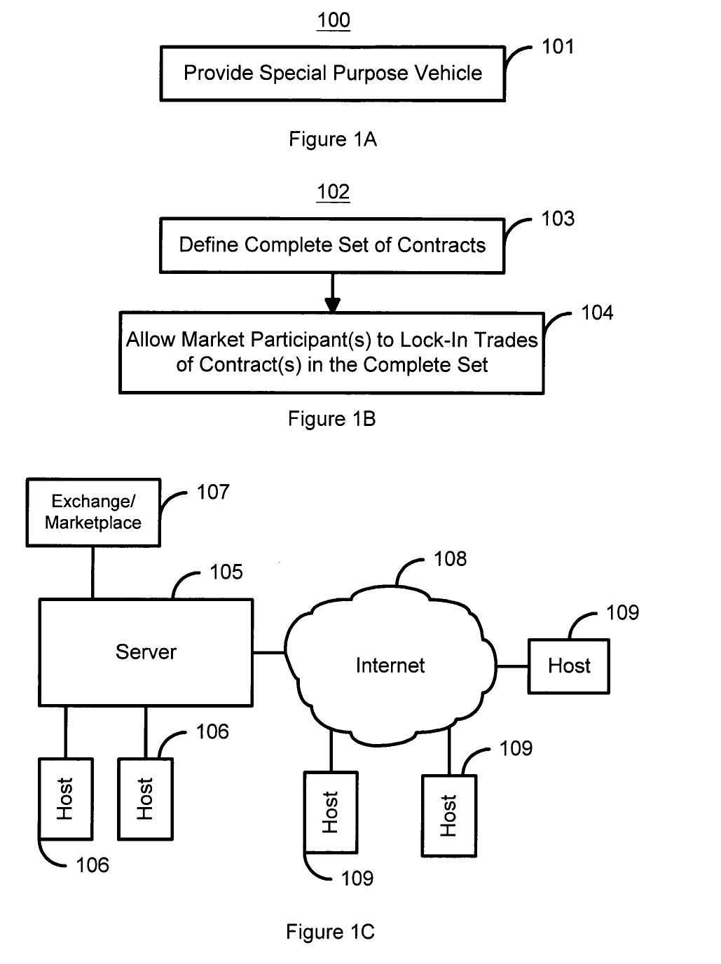

To more particularly illustrate the method and system in accordance with the present invention, refer now to FIG. 1A, depicting a high-level flow chart of one embodiment of a method 100 in accordance with the present invention for improving the liquidity of transactions. In a preferred embodiment, the method 100 is performed at least in part by software used by an exchange, bookmaker, or other financial system or market participant. However, nothing prevents the method 100 from being implemented in another fashion by another entity. The method 100 preferably deals with the kinds of contracts described above with respect to the above-identified co-pending patent application. Consequently, the method 100 preferably includes but is not limited to the aspects of the above-identified co-pending patent application.

The SPV is provided, via step 101. The SPV can buy and/or sell at least a portion of a complete set of contracts. Stated differently, the SPV can buy and/or sell contracts which may be part of the complete set. Further, the SPV can preferably also buy and/or sell contracts that are not part of any complete set. The complete set of contracts and the contracts themselves are preferably analogous and/or the same as the complete set and contracts described in the above-identified co-pending patent application. Thus, the complete set guarantees at least an initial settlement at at least one particular time. The complete set also corresponds to a settlement value, which is determined based upon the initial settlement value. Preferably, the settlement value is determined based upon the initial settlement value and an interest rate effect, if necessary. However, there may also be another relationship between the settlement value and the initial settlement value. The settlement value is thus the initial settlement value when an interest rate is accounted for. Each of the plurality of contracts maturing upon at least one particular event occurring, which preferably corresponds to the initial settlement value. The contracts are preferably mutually exclusive and completely exhaustive. However, this need not be the case. Furthermore, the complete set can preferably be exchanged for the initial settlement upon at least particular time occurring. In a preferred embodiment, the complete set can also be exchanged for the settlement value at another time.

The SPV is capable of assembling complete sets of contracts and/or selling portions of the complete set or complete sets in their entirety. As a result, the SPV can obtain the settlement value in exchange for the complete set when desired. For example, the SPV might assemble the complete set when the sum of the prices of the individual contracts is less than or equal to the settlement value. Similarly, the SPV might sell the contracts individually when the sum of the bids is greater than or equal to the settlement value. Furthermore, the SPV might buy and/or sell contract(s) or complete set(s) when other conditions are fulfilled, depending upon the conditions input by the administrator of the SPV, such as the exchange. Note that although the SPV is capable of buying and/or selling contract(s) in the complete set, in one embodiment, the step of providing the SPV can be considered to be separate from a step of allowing the SPV to buy and/or sell the contract(s) in the complete set.

FIG. 1B depicts another embodiment of a method 102 in accordance with the present invention for improving liquidity of transactions for a plurality of contracts. A complete set of contracts including the plurality of contracts is defined, via step 103. Each of the plurality of contracts matures upon at least one particular event occurring. The complete set guarantees an initial settlement value and corresponds to a settlement value. The settlement value is preferably determined based on the initial settlement value and an interest rate effect. Also in a preferred embodiment, the complete set corresponds to the settlement value and/or initial settlement value regardless of whether the at least one particular event occurs for any of the plurality of contracts. Thus, step 102 is analogous to technology described in the above-identified co-pending application. At least one market participant is allowed to lock in a trade for a portion of the plurality of contracts, via step 103. The portion of the plurality of contracts can include multiple contracts. In one embodiment, the definition of the complete set can be performed using the same system with which the SPV is provided.

FIG. 1C is a block diagram of one embodiment of a system in accordance with the present invention for improving the liquidity of contracts. The system includes a server 105 that implements at least a portion of the methods 100 and/or 102. Also in a preferred embodiment, the server 105 executes at least a portion of the methods 140, 160, 170, 180 and 190, described below. The server 105 is coupled with the exchange or marketplace 107. Although depicted as directly connected to the server 105, the data for the exchange/marketplace 107 may be obtained through the Internet 108. The server 105 may also be coupled to hosts 106 through a network and, via the Internet 108, to hosts 109. The server 105 preferably monitors the exchange/marketplace 107 to obtain information related to the price of the contracts and bids for contracts. The server 105 preferably provides the SPV in step 101. For example, the server 105 may execute software which defines the SPV. In another embodiment, the server might simply facilitate the operation of an SPV, for example an SPV corresponding to one or more market participants. In addition, the server 105 can transmit information; such as the contracts in the complete set, the settlement value, and the desire to engage in a transaction (buy/sell); to the exchange/marketplace 107. The SPV thus trades contracts in the exchange/marketplace 107. Furthermore, the server 105 may transmit such information to the hosts 106 and/or 109. The hosts 106 and/or 109 may thus be used by market participants to obtain information about the complete set(s) of contracts and to buy and/or sell contracts in the complete set from the SPV. In addition, one or more of the hosts 106 and/or 109 may be used by authorized individual(s) to configure and control the server 105. For example, an authorized individual may provide the program defining the SPV to the server through the host(s) 106 and 109. Thus, the method 100 may be implemented using the system depicted in FIG. 1C.

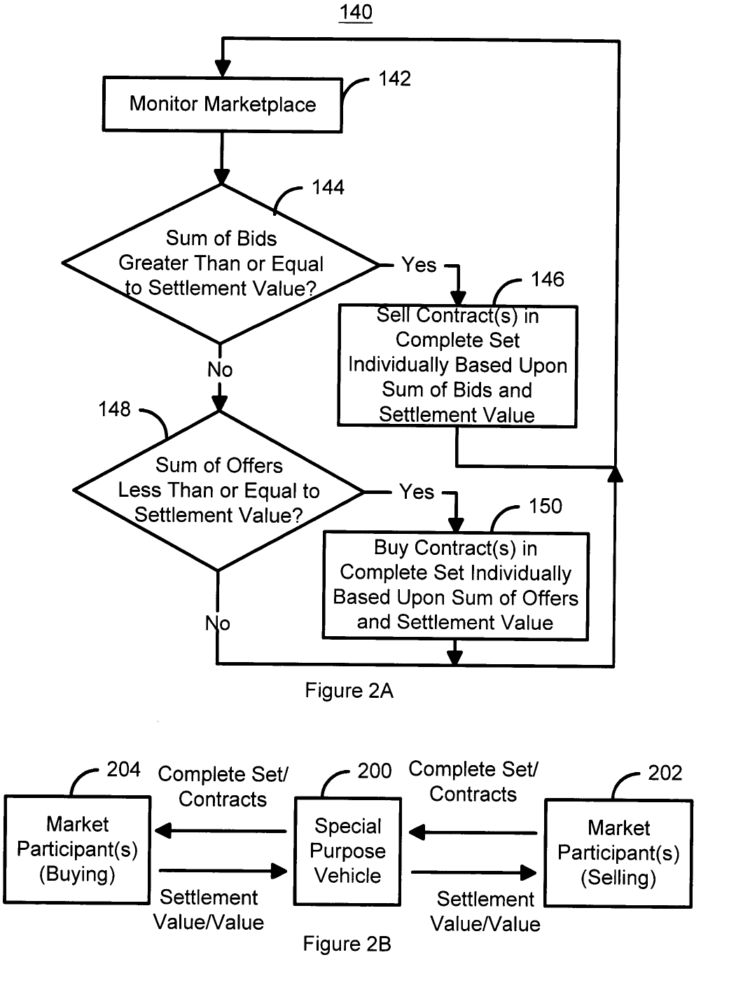

FIG. 2A is a more detailed flow chart depicting one embodiment of a method 140 in accordance with the present invention for using the special purpose vehicle for buying and selling contracts. In a preferred embodiment, the method 140 is performed at least in part by software used by an exchange, bookmaker, or other financial system or market participant. However, nothing prevents the method 140 from being implemented in another fashion by another entity. The method 140 preferably deals with the kinds of contracts described above with respect to the method 100. Consequently, the method 140 preferably includes but is not limited to the aspects of the method 100.

The SPV monitors the market, via step 142. It is determined, based on the information obtained in step 142, whether the sum of the bids for individual contracts in a complete set meets certain criteria, via step 144. Preferably, step 144 determines whether the sum of the bids for individual contracts in a complete set is greater than or equal to the settlement value, via step 144. As a result, the SPV can rapidly determine whether to sell contract(s), which contract(s) to sell, and how many contract(s) to sell. If the sum of set(s) of bids meets the criteria, then the SPV sells complete set(s) of contracts, via step 146. In a preferred embodiment, if the sum of the set(s) of bids is greater than or equal to the settlement value, then the SPV individually sells one or more complete sets of the contracts (or portion of the complete set) to the market participants. Note that the SPV may have previously obtained the complete set sold in step 146 by paying market participant(s), an organizer of the exchange/marketplace 107, or other entity the settlement value. The SPV might also short the contracts in the complete set. In addition, in a preferred embodiment, the SPV may secure the trades at essentially a single moment in time for all of the contracts sold. As a result, the legging risk can be substantially reduced or eliminated. Otherwise, the SPV determines, based upon the information obtained in step 142, whether the sum of the offer prices meets particular criteria, via step 148. In a preferred embodiment, it is determined in step 148 whether the sum of the offer prices is less than or equal to the settlement value. In another embodiment, step 148 determines whether the sum of the offer prices is less than the settlement value, via step 148. Step 144 could be performed using order slicing. Order slicing presents information to market participants in a particular manner to allow market participants to better decide whether to exchange the complete set for the settlement value or vice versa. In a preferred embodiment, order slicing provides the information in a matrix that matches each plurality of contracts with any bid or offer for each plurality contracts. In addition, the bids and offers are preferably ranked in order based upon the price of the bid or offer. For example, the columns in the matrix would correspond to the contracts. The rows would correspond to the offers or bids, preferably ranked from highest to lowest. Thus, it could be more rapidly understand whether the sum of the bids for a complete set is greater than or equal to the settlement value. Similarly, it could be more rapidly understand whether the sum of the offers for a complete set is less than or equal to the settlement value. As a result, the SPV can determine whether to buy contracts, which contracts to buy, and how many contracts to buy.

Based upon the sum of the set(s) of offers, the SPV may assemble one or more of the complete set(s) of contracts, via step 150. In one embodiment, if the sum of set(s) of offers is less than or equal to the settlement value or, in an alternate embodiment, less than the settlement value, then the SPV assembles one or more of the complete sets of contracts by individually buying contracts, via step 150. In an alternate embodiment, the SPV might assemble the complete set(s) of contracts in step 150 when the sum of the offers is greater than the settlement value by a particular amount. Thus, the SPV may assemble the contract set(s) in step 150 when a loss would be incurred. Step 150 can include the SPV individually buying all of the contracts in the complete set(s) to assemble one or more complete sets of the contracts. However, when the SPV already holds a portion of the complete set(s), step 150 can include the SPV individually buying a remaining portion of a complete set(s). Thus, the SPV assembles one or more of the complete sets of contracts by individually buying contracts in the complete set. In one embodiment, the SPV may assemble the contract set(s) in step 150 when the sum of set(s) of offers is less than or equal to the settlement value because the SPV may be owned by an exchange. In such a case, the exchange may make a profit based upon the exchanges which take place between the special purpose vehicle and other market participants. As a result, the exchange can make a profit even when the sum of the set(s) of offers is equal to (or in some cases, greater than) the settlement value. Consequently, the SPV may assemble the complete set even in these cases not only to increase liquidity, but also to provide the exchange with a profit. Moreover, in an alternate embodiment, the SPV may assemble the contract set(s) in step 150 when a loss would be incurred. This is because the SPV may simply be used to increase liquidity. In addition, the SPV may be taken into account transaction costs such as taxes, statutory levies or commissions in determining whether to make the trades that assemble the contract set(s) in step 150. Step 142 may then be returned to.

In addition, in a preferred embodiment, the SPV may secure the trades at essentially a single moment in time for all of the contracts bought in step 148. The SPV may exchange the contracts obtained in step 150 as a complete set in exchange for the settlement value. However, the exchange of the complete set is typically performed at a different time than the steps 146 and 150 because it is believed that market participants will desire to make the exchange with the SPV when conditions opposite to steps 146 and 150, respectively, prevail. For example, it is believed that market participants will want to exchange the complete set for the settlement value when the sum of the bid prices is less than the settlement value, and vice versa. Note that although the method 140 is described in the context of the settlement value, the interest rate effect is also preferably taken into account. Thus, an amount less than the settlement value by the interest rate effect (i.e. the present value calculation) may be used in step 148 and an amount less than the settlement value by the interest rate effect may be used in step 144.

Thus, the SPV can be an additional mechanism for market participants to perform transactions. The SPV provides a mechanism for market participants to obtain the settlement value and/or the complete set of contracts. Thus, using the SPV liquidity can be improved beyond the equilibrium established using conventional mechanisms. The SPV can automatically make trades based upon the complete set, the settlement value and individual bids and offers. These transactions might not be made in the absence of the methods 100 and 140. In addition, the SPV could be used to independently obtain profits by trading individual contracts. These profits could be used to fund the constant time value of the settlement value and/or provide an additional profit to the exchange or originator of the SPV. Moreover, in the case of betting, the SPV can be used to short or long bets. Thus, participants in the betting market could utilize the SPV to short bets. The SPV, rather than individual participants, would then be considered a bookmaker. As a result, the participants in the betting market would have a greater variety of transactions to choose from without being required to be a licensed bookmaker.

FIG. 2B is a block diagram depicting one embodiment of a SPV 200 in accordance with the present invention that interacts with market participants. In one embodiment, the special purpose vehicle 200 is provided by the exchange or market maker. However, another entity can provide the special purpose vehicle 200 and enjoy the benefits achieved. The special purpose vehicle 200 interacts with market participants 202 and 204. The special purpose vehicle 200 obtains contracts from market participants 202 in exchange for value. The value could take the form of, for example, cash, goods, or a negotiable instrument. In some cases, the special purpose vehicle 200 obtains the complete set of contracts from the market participants 202 in exchange for the settlement value. The special purpose vehicle 200 sells contracts to the market participants 204 for value. Again, the value could take the form of, for example, cash, goods, or a negotiable instrument. In one embodiment, the special purpose vehicle 200 provides market participants with a complete set in exchange for the settlement value. Note that the value received or provided by the special purpose vehicle 200 could be in cash, goods, or another negotiable instrument as defined above. The special purpose vehicle 200 preferably has the same abilities as the exchange window 200. Thus, the same benefits as for the exchange window 200 could be enjoyed using the special purpose vehicle 200. In addition, the special purpose vehicle can make trades automatically, can assemble a complete set, and obtain its own profit.

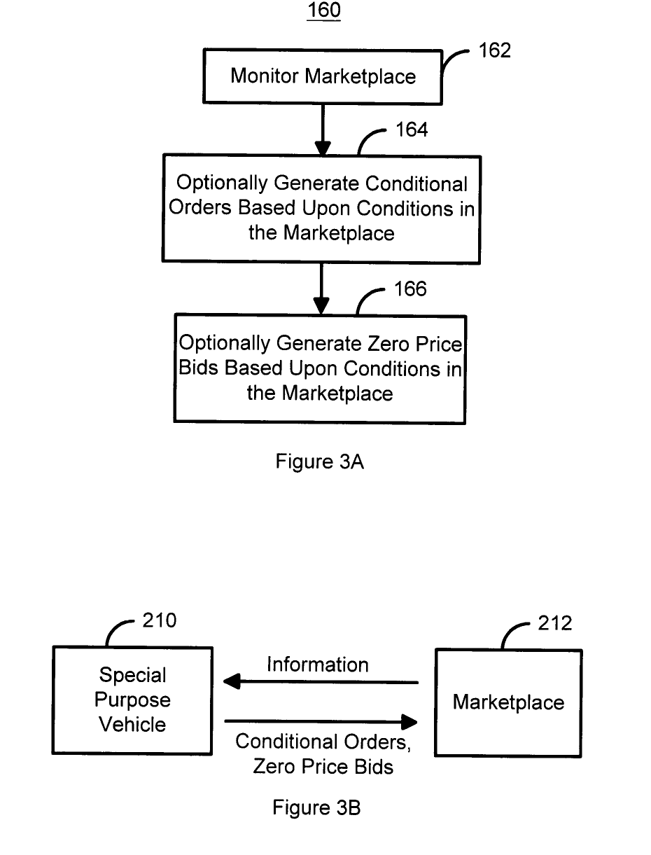

FIG. 3A is a more-detailed flow chart depicting one embodiment of a method 160 in accordance with the present invention for using the SPV to generate orders and improve the liquidity of transactions. The SPV monitors the marketplace, via step 162. Based on the conditions in the marketplace, the SPV may generate conditional order(s), via step 164. A conditional order is an order, to buy or sell, that has a corresponding condition. The conditional order(s) may be offer(s) to sell contract(s) at particular price(s) and/or bid(s) to buy contract(s) at certain other price(s). In a preferred embodiment, the SPV may generate conditional order(s) to sell contract(s) in the complete set when the sum of the prices for bids to buy contract(s) is less than the settlement value. Also in a preferred embodiment, the SPV may generate conditional order(s) to buy contract(s) in the complete set when the sum of the prices for offers to sell contract(s) is greater than the settlement value. Thus, the SPV generates conditional order(s) in step 164 when the price(s) of bids and offers is such that even with the complete set(s) and the settlement value, the contracts would not be bought or sold. Stated differently, the SPV generates conditional order(s) when the marketplace would otherwise be in equilibrium. The condition that corresponds to the conditional order(s) is that the corresponding contract(s) in the complete set also be bought or sold. Furthermore, the SPV may generate zero price bids in addition to or in lieu of conditional orders based upon the market conditions, via step 166. A zero price bid is a bid to buy a contract at a price of zero. The zero price bid may be considered to be a special case of step 164, generating conditional orders. The zero price bid is used to allow the SPV to sell contract(s) in complete set(s) and allow market participants to assemble the complete set(s) if desired.

FIG. 3B is a block diagram depicting one embodiment of a SPV 210 in accordance with the present invention that interacts with market participants through the marketplace 212. The SPV 210 obtains information from the marketplace 212 relating to the contracts and prices. The SPV also provides to the marketplace conditional orders and/or zero price bids based upon the market conditions for particular complete set(s) of contracts.

For example, suppose that the complete set include two contracts, C1 and C2. Also suppose that the settlement value is $100 and that bids (all of quantities of one each) are (with absence of market offers) are shown in Table 1.

TABLE 1

| Type | Contract C1 | Contract C2 |
|---|---|---|
| Bid | $29 | $70 |
| Offer | | |

Thus, the sum of the bids for the contracts is less than the settlement value. A conditional order to sell (conditional offer) for contract C2 can be generated by the SPV 210. The conditional offer for C2 would be for an amount such that the sum of the prices is greater than or equal to the settlement value. Thus, the conditional offer for C2 could be $71. The condition would be that the bid of $29 for C1 would be available if and when the conditional offer at $71 is being filled. Similarly, a conditional order to sell (conditional offer) for C1 could be generated by the SPV 210. The conditional offer would be such that the sum of the prices is greater than or equal to the settlement value. Thus, the conditional offer for C1 could be $30. The condition would be that the bid for C2 at $70 would be available if and when the conditional offer at $30 is being filled. Note that the conditional order(s) generated in step 164 could have different quantities, again depending upon the market conditions and the quantities for bids and/or offers in the marketplace. Thus, the number of transactions may increase, and the bid-offer spread (difference between the bid price and offer price) may decrease. The above example illustrates that (conditional) offer orders can be generated even in the absence of natural sell orders. The method and system in accordance with the present invention will therefore help to address the structural problem of many markets: most of the natural demand being on the buy/bid side and a lack of natural selling/short sellers/market makers in its initial stage eventually leading to market failure.

For another example, suppose that the complete set include two contracts, C1 and C2. Also suppose that the settlement value is $100 and that offers (all of quantities of one each) are (absence of market bid orders) are shown in Table 2.

TABLE 2

| Type | Contract C1 | Contract C2 |
|---|---|---|
| Bid | | |
| Offer | $30 | $71 |

The sum of the offers for the contracts is greater than the settlement value. A conditional order to buy (conditional bid) for contract C2 can be generated. The conditional bid for C2 would be for an amount such that the sum of the prices is less than or equal to the settlement value. Thus, the conditional bid for C2 could be $70. The condition would be that the offer of $30 for C1 would be available if and when the conditional bid at $70 is being filled. Similarly, a conditional order to buy (conditional bid) for contract C1 can be generated. The conditional bid for C1 would be for an amount such that the sum of the prices of C1 and C2 is less than or equal to the settlement value. Thus, the conditional bid for C1 could be $29. The condition would be that the offer of $71 for C2 would be available if and when the conditional bid at $29 is being filled. Note that the conditional order(s) generated in step 164 could have different quantities, again depending upon the market conditions and the quantities for bids and/or offers in the marketplace. Thus, the number of transactions may increase, and the bid-offer spread (difference between the bid price and offer price) may decrease.

In another example, suppose that the complete set include two contracts, C1 and C2. Also suppose that the settlement value is $100 and that offers and bids (all of quantities of one each) are shown in Table 3.

TABLE 3

| Type | Contract C1 | Contract C2 |
|---|---|---|
| Bid | $29 | $70 |
| Offer | $30 | $71 |

The sum of the bids for the contracts is less than the settlement value, while the sum of the offers is greater than the settlement value. A conditional order to buy (conditional bid) for contract C2 can be generated by the SPV 210. The conditional bid for C2 would be for an amount such that the sum of the prices is less than or equal to the settlement value. Thus, the conditional bid for C2 could be $70. The condition would be that the offer of $30 for C1 would be available if and when the conditional bid at $70 is being filled. Similarly, a conditional order to sell (conditional offer) for C2 could be generated. The conditional offer would be such that the sum of the prices is greater than or equal to the settlement value. Thus, the conditional offer for C2 could be $71. The condition would be that the bid for C1 at $29 would be available if and when the conditional offer at $71 is being filled. Note that other conditional offers and bids could be generated with the above scenario (i.e. conditional bid and offer of $29 and $30 respectively for C1, each of quantity of one). Furthermore, note that the conditional order(s) generated in step 164 could have different quantities, again depending upon the market conditions and the quantities for bids and/or offers in the marketplace. Thus, the number of transactions may increase, and the bid-offer spread (difference between the bid price and offer price) may decrease.

As a further example, suppose that the complete set include two contracts, C1 and C2. Also suppose that the settlement value is $100 and that offers (all of quantities of one each) are (absence of market bid orders):

TABLE 4

| Type | Contract C1 | Contract C2 |
|---|---|---|
| Bid | | |
| Offer | $101 | $103 |

Thus, the sum of the offers for the contracts is greater than the settlement value. A conditional order to buy (conditional bid) for contract C2 can be generated by the SPV 210. The conditional bid for C2 would be for an amount such that the sum of the prices is less than or equal to the settlement value. However, if same calculation as before were used, the conditional bid for C2 would be −$1. Since the price has a natural floor of zero, a price of −$1 would be invalid, therefore conditional bid for C2 will not be generated. Similarly, a conditional order to buy (conditional bid) for contract C1 can be generated. The conditional bid for C1 would be for an amount such that the sum of the prices is less than or equal to the settlement value. However, if same calculation as before were used, the conditional bid for C1 would be −$3. Because the price has a natural floor of zero, a price of −$3 would be invalid, conditional bid for C1 is preferably not generated.

Zero price bids can be used to generate conditional offers. A zero price bid is generally a bid assumed by the SPV 210, or other entity, for one or more contracts at a price of zero. The existence zero price bid can be considered to be a condition on the corresponding conditional offer generated using the zero price bid. For example, suppose a complete set compose of C1, C2 and C3. Further suppose there is no bid/offer for C1 and only one bid each for C2 and C3, each of quantity one. Thus, the current state of the market is shown in Table 5.

TABLE 5

| Type | Contract C1 | Contract C2 | Contract C3 |
|---|---|---|---|
| Bid | | $50 | $29 |
| Offer | | | |

Following the method described previously, a conditional offer for C1 can be generated based on market bids on C2 and C3. The conditional offer for C1 is of quantity one and price $21 ($100−$50−$29). Similarly, the SPV could assume as if there was a market bid available for C1 at a price of $0 and quantity of one. In fact, the zero price bid can be of any quantity to facilitate trading. The SPV may, therefore, be able to generate conditional offers for C2 and C3. The conditional offer for C2 would be of quantity one and price 71. This corresponds to the settlement value minus the sum of the prices of the remaining contracts (zero for C1 and $29 for C3). Similarly, the conditional offer for C3 would be of quantity one and price $50, or $100−$0−$50 (settlement value minus price of C1 minus price of C2). Because more conditional orders are generated and further transactions may take place, liquidity would be improved. In addition, if either C2 or C3 conditional order is traded, the SPV 210 would have the capacity to sell one unit of C1 in the future at basically any desired price (greater than or equal to zero), since such contract is effectively bought at zero price (from the zero price bid). Such a sale action for C1 in the future will improve liquidity of C1. Alternatively, the SPV 210 may unwind the position subsequently in the market by buying C2 and C3 only (rather than a complete set) for less than or equal to the settlement value. This potentially will improve liquidity of C2 and C3.

The method and system in accordance with the present invention would also help to improve liquidity when bids in aggregate are sufficiently high enough (offers in aggregate low enough). Suppose after the interest rate effect, the settlement value of a complete set is $99 and the market starts with only three bids, one for each contract and each of quantity one:

TABLE 6

| Type | Contract C1 | Contract C2 | Contract C3 |
|---|---|---|---|
| Bid | $35 | $25 | $40 |
| Offer | | | |

By the same token, conditional offer will be generated for C1 (offering at $34=$99−$25−$40), C2 (offering at $24=$99−$35−$40) and C3 ($39=$99−$25−$35). Note that any and all of the conditional offers are lower than market bids. The conditional offer will match with the market bid to make the trade, and the result will be the same for either one (and only one) of trading of C1, C2 or C3. For the amount of $1, (market bid of $35 against $34 for the conditional offer, or similar for C2 or C3), the exchange can set the rule beforehand. For example, the $1 can be redistributed to market buyers of C1, C2 and C3 proportional to their bid prices. For another example, the SPV can pocket the $1 as profit. Similarly, if the offers in aggregate are lower than settlement value of $99, conditional bids will match a trade, one complete set traded eventually, therefore liquidity improved.

Note that this can be a trade by the SPV, or this can be a service offered to market participant. The service is that conditional offer(s) will be generated on behalf of the market bids involved. Once trading is done, exchange window will be accessed automatically. With the profit is distributed in any way, there is no need for a permanent entity like SPV to facilitate the trade.

In addition, if the trade is offered as a service, suppose the market starts by two orders below and conditional offer for C1 is not generated yet (e.g. speed of the system). Assume settlement value is the same as $99:

TABLE 7

| Type | Contract C1 | Contract C2 | Contract C3 |
|---|---|---|---|
| Bid | | $70 | $10 |
| Offer | | | |

If a market participant A wants to place a bid at $21 for C1, before the order is even shown on the screen to other market participants as pricing information, the trade would have been done. The SPV, if any, is executing the trade on behalf of market participant A. On behalf of A, the SPV searches for two buyers from C2 and C3. Upon aggregate bids being high enough, the bid of market participant A need not be put into the queue. Instead, it is already matched. Instead of the SPV, one may consider market participant being offered an order matching service and automatic access to the Exchange Window. Again, the difference of $2 (bid of $21+$70+$10=$101, $2 higher than settlement value) would be distributed according to rule (such as distributing to all orders involved in complete set trading).

Thus, the method and system in accordance with the present invention is not limited to the above examples of two contracts for a complete set. Conditional bids and offers could be generated by SPV 210 for complete sets of a plurality of contracts in a similar manner. Conditional orders could also be generated for combination orders. For example, suppose a complete set of contracts is C1, C2 and C3 and that the settlement value is one hundred. Further suppose the market bids are:

TABLE 8

| Type | Contracts | Price (total) |
|---|---|---|
| Bid | 1 × C1, 2 × C3 | $120 |
| Bid | 1 × C2 | $29 |

Based on the 2 bids above, conditional offer can be generated: 1×C1 and 1×C2 at a price of fifty-one. The combination of conditional offer adds up with the two market bids to form 2 complete sets (2xC1, 2xC2, 2xC3). The conditional offer price is implied by two times the settlement value, or two hundred minus the price limits of the two bids listed in Table 8, or ($200−$120−$29=$51). Thus, conditional orders can be generated for combinations, zero price bids, and non-combination orders.

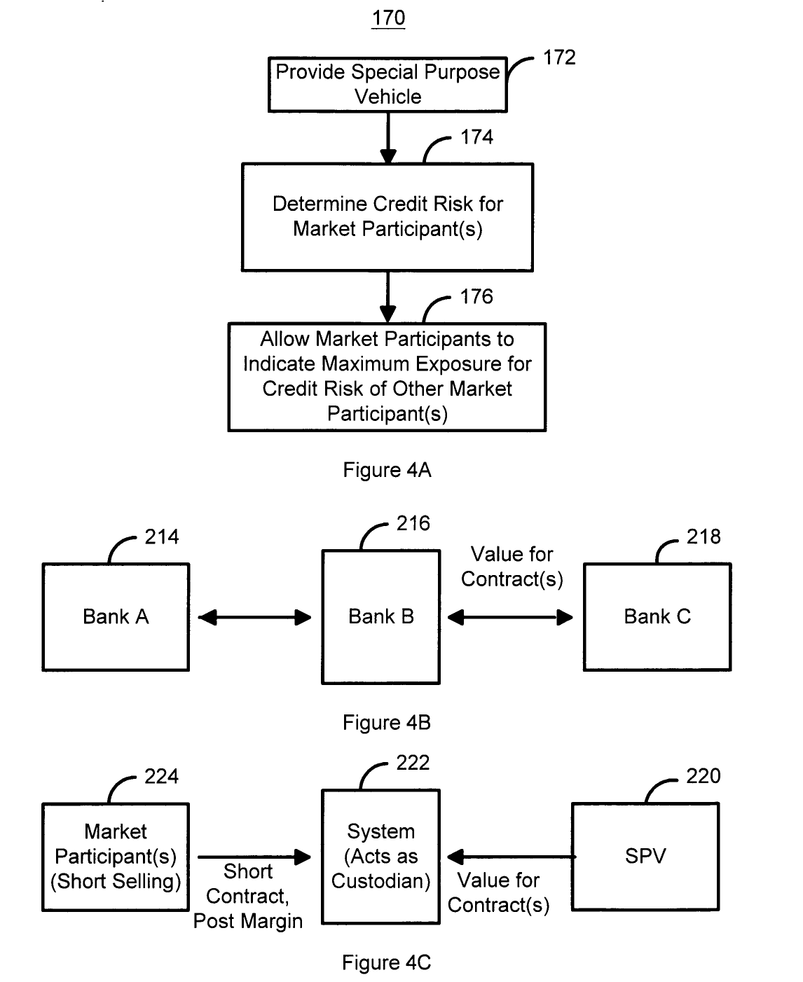

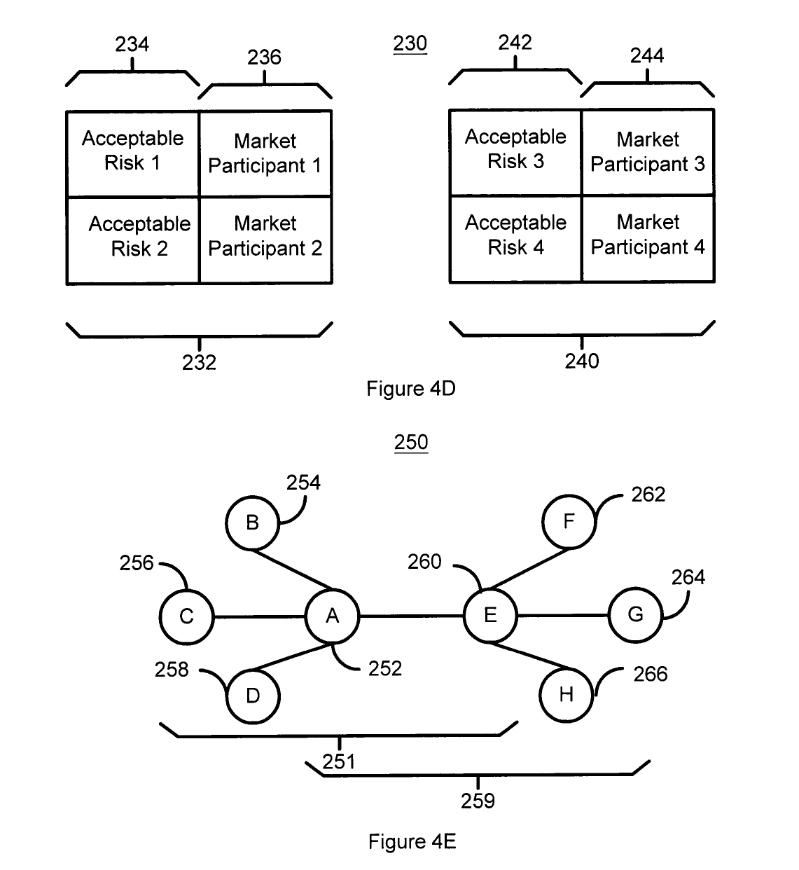

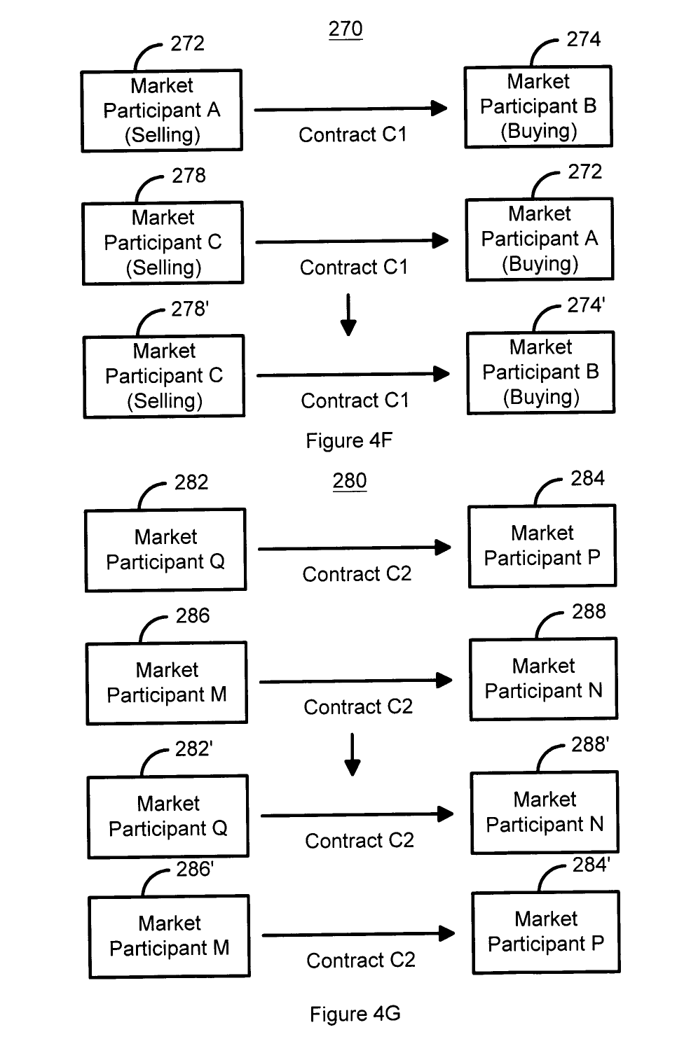

FIG. 4A is a flow chart depicting one embodiment of a method 170 in accordance with the present invention for managing credit related risks utilizing a SPV in accordance with the present invention. The special purpose vehicle is provided, via step 172. The credit risk for certain market participants holding contract(s) is determined, via step 174. Because of the ability of the SPV to buy and/or sell contract(s) in complete set(s), and the definition of a complete set, the credit risk can be determined in step 174. In other words, the ability of the SPV to buy and/or sell contracts reduces the credit risk to a zero sum game. The credit risk is preferably a maximum credit risk. In a preferred embodiment, step 174 is implemented by subtracting the price(s) of contract(s) from the payout if the contract wins upon maturity for contract(s). For example, suppose a market participant is (short) selling a contract for $34 and that the winning payout is $100. The maximum credit risk is the risk that the contract holder will sell the contract and that the contract will be a winner paying out $100. This translates to a (maximum) credit risk of the winning payout minus the contract price, $66. For a short sale, this difference would be the margin posted by the market participant short selling the contract. The market participant would preferably post the margin with the SPV. In such a case, the SPV is acting as a safe keeper for the margins until the winning contract is determined. The SPV collects the margin of $66 from the short-seller and the $34 (the buy price) from the buyer. The SPV therefore acts as custody for the total amount of $100 and waits until settlement value of $100 is payable. That $100 is then paid to the complete set (or the winning contract) according to the outcome and definition of the contract set. In the case where the market participant is buying, the maximum risk can also be determined based upon the winning payout and the contract prices. For example, suppose the contracts in a complete set are C1, C2, and C3, each of which is bought by a market participant. Suppose the maximum payout is $100 and that prices are as follows:

TABLE 9

| Market | | Price Paid | Maximum | Credit Risk | Credit Risk |
|---|---|---|---|---|---|
| Participant | Contract | for Contract | Gain if Wins | Party | Amount |
| Customer 1 | C1 | $34 | $66 | Customer 2 | $50 |
| | | | | Customer 3 | $16 |
| | | | | | (total $66) |
| Customer 2 | C2 | $50 | $50 | Customer 1 | $34 |
| | | | | Customer 3 | $16 |
| | | | | | (total $50) |
| Customer 3 | C3 | $16 | $84 | Customer 1 | $34 |
| | | | | Customer 2 | $50 |
| | | | | | (total $84) |

Thus, the (maximum) credit risk for each market participant can be determined because of the ability of the SPV to buy and/or sell contracts and the definition of complete set(s) of contract(s) that have a guaranteed return.

Similarly, suppose the contracts in a complete set are C1, C2, and C3, each of which is sold (short) by a market participant. Suppose the maximum payout is $100 and that prices are as follows:

TABLE 10

| | | | Maximum | Credit Risk | |
|---|---|---|---|---|---|
| | | | Loss if | Party - | |
| | | | shorted contract | payable if | |
| Market | | Sale Price | Wins = margin | shorted | Credit Risk |
| Participant | Contract | for Contract | posted | contract wins | Amount |
| Customer A | C1 | $36 | $64 | Customer B | $34 |
| | | | | Customer C | $30 |
| | | | | | (total $64) |
| Customer B | C2 | $34 | $66 | Customer A | $36 |
| | | | | Customer C | $30 |
| | | | | | (total $66) |
| Customer C | C3 | $30 | $70 | Customer A | $36 |
| | | | | Customer B | $34 |
| | | | | | (total $70) |

The margin posted will exactly cover the amount payable to the other two customers. Thus, the (maximum) credit risk for each market participant can be determined because of the ability of the SPV to buy and/or sell contracts and the definition of complete set(s) of contract(s) that have a guaranteed return.

Because the credit risk can be determined in step 174, the market participants are also allowed to define the credit risk they would be willing to take with other market participants, via step 176. In a preferred embodiment, step 176 is preferably performed by allowing market participants to provide one or more matrices indicating the credit risk allowed for a portion of the remaining market participants. As a result, the credit risk acceptable to each market participant can be allocated. Furthermore, decentralized trading is possible. In other words, each market participant can define the maximum exposure that market participant is willing to assume for a set of other market participants. These market participants can trade with each other and, in effect have their own marketplace. Decentralized trading can take place in the absence of SPV, so long as the safekeeping role is not needed and information is exchanged amongst the market participants. Suppose that market participants have very high trust with each other such that no payment is needed initially when trades begin. Payment will only be made at settlement when outcome is determined. Therefore SPV can function just as a booking entity, recording the trade details. Settlement payment may also be direct between market participants. Therefore SPV having all of the functions previously described may not be needed—only a record-keeping device is used. Market participants would effectively be trading direct with each other.

The above illustrates that the SPV's safekeeping role can be replaced by market participants. This situation is illustrated in FIG. 4B, in which banks 216, 218, and 220 can trade. This applies, for example, to buy/short-sell orders, buy orders of complete sets, and sell orders of complete sets. In addition, market participants can be replaced by trustworthy entities, such as financial intermediaries. For example, a retail bank can trade on behalf of customers. Different retail banks can deal directly with each other without the SPV 210. The banks can trade with each other like inter-bank market. For example, suppose 3 market participants (end user) P, Q and R, represented by 3 retail banks A, B and C, transact the following trades for a complete set including contracts Cx1, Cx2, and Cx3. The situation is depicted in Table 11.

TABLE 11

| | | |
|---|---|---|
| End User P | Retail Bank A | Buy C × 1 at $50 |
| End User Q | Retail Bank B | Buy C × 2 at $30 |
| End User R | Retail Bank C | Buy C × 3 at $20 |

Instead of payment to the SPV 210, the following three deposits are created: Deposit of fifty dollars to Retail Bank A 214, deposit of thirty dollars to Retail Bank B 216, and deposit of twenty dollars to Retail Bank C 218. The deposit could either be (i) in the name of P/Q/R and pledged to the retail bank A/B/C, or (ii) in the name of retail bank A/B/C which are safe-keeping on behalf of P/Q/R. Interest income may be payable to P/Q/R just like deposit to bank A/B/C, therefore neutralizing the interest rate effect.

In addition, the end users and retail banks may want to perfect the scheme to safeguard the unrealized profit/loss of contract positions. For example, if in the example above, the price of Cx1 rises to $70 from $50, P would want his position to be backed by $70 (cost plus profit) rather than the initial amount of $50. One way of doing so is to have a regular mark-to-market (e.g. end of every business day) contract values. After mark-to-market, money will be transferred between banks to cover the profit/loss. Therefore the end users' position could be fully backed by deposit of his bank based on updated contract pricing. Reference contract prices for mark-to-market will still obey CTS (i.e. the complete set of contracts will still correspond to at least the settlement value). Notice that given the CTS, after the mark-to-market transfer the net cash flow will be zero. In other words, the transfer is a zero sum game amongst retail banks. End users would not need to top up cash in order to fulfill the mark-to-market transfer.

FIGS. 4C-4G depict block diagrams of embodiments of a special purpose vehicle in accordance with the present invention that interact with market participants to manage credit related risks. FIG. 4C depicts the interaction between the SPV 220, the market participant 224, and the system, marketplace, bank, or exchange 222. The SPV 220 can buy contract(s) in the complete set from the system 222. For example, suppose that the price of a particular contract in a complete set is $34. The SPV 220 would pay $34 to the system 222. The market participant 224 may choose to short sell the contract. Assuming that the winning payout is $100, the margin paid by the market participant 224, as well as the credit risk, is $66. This amount is also paid into the system 222. In such a case, the exchange or system 222 is merely the custodian for the winning payout (the price $34 plus the margin $66). Furthermore, as described above with respect to step 174, the credit risk is determined because of the SPV's 220 ability to buy contracts at the contract price. As described above with respect to step 174, this credit risk is preferably the margin. In the case where the SPV 220 sells contract(s), the market participant(s) may pay the SPV 220, possible through the system 222. The SPV 220 may put the money received in an interest bearing account or other mechanism for accounting for interest rates. In addition, as described above, the credit risk for each of the market participants can be determined based upon the prices of the contracts and the winning payout.

FIG. 4D depicts a system 230 indicating the maximum exposure that a market participant is willing to risk for a set of other marketplace. The market participant has included two matrices 232 and 240 for different sets of market participants from whom the market participant is willing to accept risk. The matrix 232 indicates the market participants 236 and the corresponding acceptable credit risk 234. Similarly, the matrix 240 includes another set of market participants 244 and corresponding risks 242. Thus, market participants can define the acceptable risk for other market participants and can engage in independent trading with these other market participants.

FIG. 4E depicts a system 250 indicating the relationship between groups 251 and 259 of market participants. Market participants A 252, B 254, C 256, and D 258 have identified the maximum exposure acceptable through step 176 and are thus able to independently and safely trade with each other. Similarly, market participants E 260, F 262, G 264 and H 266 have identified the maximum exposure acceptable through step 176 and are thus able to independently and safely trade with each other. Furthermore, if A 252 and E 260 establish relationship and agree to exchange market information between them and only between them, A 252 and E 260 will effectively reside in both groups 251 and 259. Thus, market participants A 252 and E 260 may be able to engage in arbitrage, buying and selling contracts from market participants in one group to another group. A 252 and E 260 are effectively merging the markets of the groups 251 and 259 to their benefits. Their arbitrage activities are only limited by the maximum exposure for credit risk between the two. Notice that A 252 and E 260 may commercially be one entity, presenting in the 2 groups as separate identities to profit the information advantage. A 252 and/or E 260 are described as arbitrageur, his activities of which would increase market trading volume and therefore help to improve liquidity.

FIG. 4F depicts a system 270 for credit netting based upon the method 170. Market participants A 272 can engage in transactions with market participants B 274 and C 278. For example, at time t=1 A 272 sells to B 274 one contract of C1 and subsequently at time t=2 A 272 buys from C 278 one contract of C1. Suppose market participants B 274 and C 278 have defined their matrices of acceptable exposure such that C 278 is in B 274's matrix and vice versa. Because both market participants B 274 and C 278 can interact with each other, the net effect is that market participant B 274 can engage in transactions with market participant C 278 directly. The overall credit risk is reduced from two (first one between A 272 and B 274, and second one between A 272 and C 278) to one (between B 274 and C 278). Depending on the prices traded at t=1 and t=2, there may be a residual credit risk between A 272 and B 274, and/or a residual risk between A 272 and C 278. Note that if the price traded at t=1 is equal to the price traded at t=2, there is zero residual credit risk. However, in normal circumstances (e.g. if the prices traded for t=1 and t=2 are not of too great difference), the majority of credit risk will rest on between B 274 and C 278 after netting.

For example, suppose at time t=1 A 272 sells to B 274 one contract C1 at a price of $50. At time t=2 A 272 buys from C 278 the same contract C1, quantity one at price of $48. By credit netting, the two trades will be consolidated to one of two possibilities. In the first possibility, C 278 sells/B 274 buys one contract C1 at $48. In addition, B 274 has a payable to A 272 for $2. The $2 represents the profit of A 272 by selling high ($50) and buying low ($48). As the new trade for B 274 to buy is $48 instead of $50, the apparent “savings” for B 274 to buy at $2 lower is in fact payable to A 272 (residual credit risk). Such $2 payable is not a contract trade. It is payable to A regardless of what happens to the contract price and settlement. In the second possibility, C 278 sells/B 274 buys one contract C1 at $50 and C 278 has a payable to A 272 for $2. The $2 represents the profit of A 272 by selling high ($50) and buying low ($48). As the new trade for C 278 to sell is $50 instead of $48, the apparent “gain” for C 278 to sell at $2 higher is in fact payable to A 272 (residual credit risk).

FIG. 4G depicts a system 280 for credit swapping based upon the method 170. Market participants Q 282, P 284, M 286, and N 288 have defined matrices in step 174 or 176. Q 282 can trade with P 284 and M 286 can trade with N 288. Suppose further that Q 282 has a credit matrix showing with everything being equal, Q 282 has a preference to take credit risk on N 288 over P 284 (for example, Q 282 perceives N 288 of better credit quality than P 284). If it happens that M 286 also shows a preference of reversed order (in other words, a preference for Q 282), as perception of credit can be subjective, and incremental credit preferences depend on what kind/amount of credit risk is already taken between the 2 parties) of taking credit risk on P 284 over N 288, there is a win-win situation for credit swapping. Upon consent of all four parties Q 282, P 284, M 286, and N 288, a credit swapping may be performed. If showing a preference would imply a consent, further consent will be required only for P 284 and N 288.

The credit matrices may authorize credit swapping of any kind already. In such a case, no consent from any party need be required. For example in credit swapping, the original trades are for (i) Q 282 and P 284, and (ii) M 286 and N 288. After the swap, the new trades or new credit risk would be (i) Q 282 and N 288, and (ii) M 286 and P 284. The new arrangement would be beneficial to both Q and M. Note that (i) P 284 and N 288 are assumed to be indifferent to credit risk of Q 282 and M 286. A similar analysis could be performed for credit matrices and preferences of P and N if they have ones. Even if M 286 is indifferent to credit risk of P 284 and N 288, a credit swapping, upon consent if necessary, is beneficial at least to Q 282. Note that similar to credit netting, residual credit risk may exist, depending upon the prices traded for Q 282 versus P 284, and M 286 versus N 288.

For example, suppose two trades are done—(i) Q 282 and P 284, and (ii) M 286 and N 288. Suppose further both trades are on contract C2. In trade 1, Q 282 sells/P 284 buys one C2 at a price of 19. In trade 2, M 286 sells/N 288 buys one C2 at a price of 20. If the credit preferences are as described above, after credit swapping the trades become Trade A, Trade B, and Payment C. In trade A, Q 282 sells/N 288 buys one C2 at a price of nineteen. In Trade B, M 286 sells/P 284 buys one C2 at a price of twenty. Payment C is N 288 has a payable to P 284 of $1. In such case as N 288 is buying at a price of $19, $1 lower than $20 (refer to Trade 2). At the same time, P 284 is now buying at a price of $20 instead of $19 (refer to Trade 1). N 288 will pay the $1 “savings” to P 284. Such $1 is the residual credit risk.

Alternatively, instead of Trade A, B and Payment C the trades X and Y and Payment Z can be performed. In Trade X, Q 282 sells/N 288 buys one C2 at a price of twenty. In Trade Y, M 286 sells/P 284 buys one C2 at a price of 19. In Payment Z, Q 282 has a payable to M 286 of $1. In such case, Q 282 is selling at a price of $20, $1 higher than $19 (refer to Trade 1). At the same time, M 286 is now selling at a price of $19 instead of $20 (refer to Trade 2). Q 282 will pay the $1 “gain” to M 286. Such $1 is the residual credit risk.

In addition to credit netting and swapping, credit bridging can also be achieved. In credit bridging, credit can effectively be extended to other participants. Suppose A, B, and C are market participants. B desired to buy a lot of a contract at a first price. C desires to sell a lot of the same contracts at a second price. Also assume that A can trade with and has a credit risk defined for both C and B. A can buy the contracts from C, and sell these contracts to B. In effect, B and C are trading together.

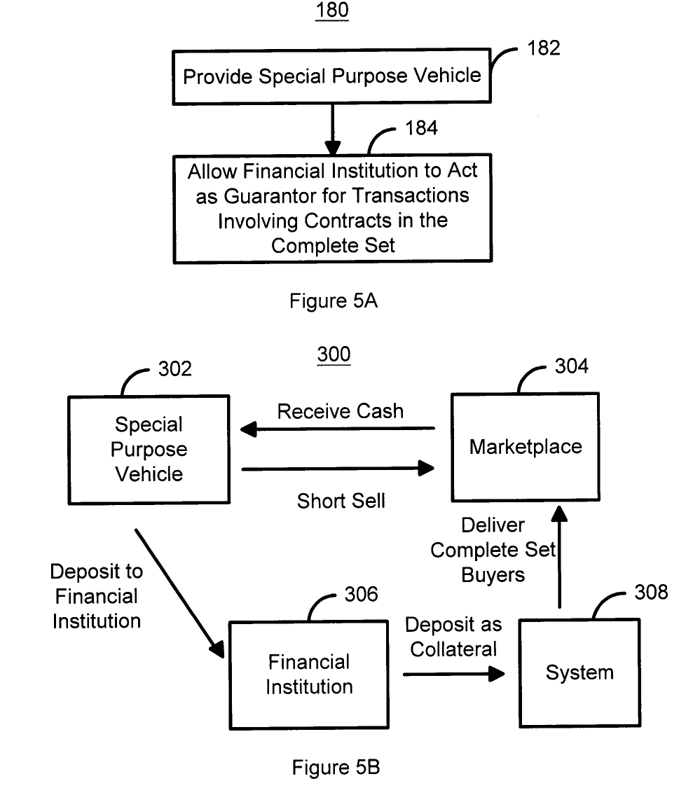

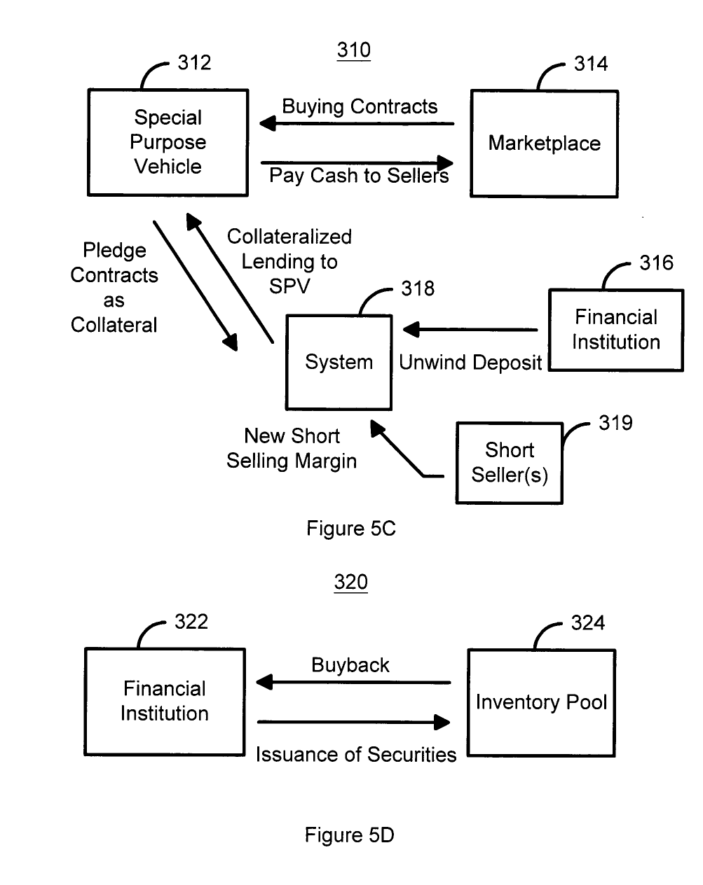

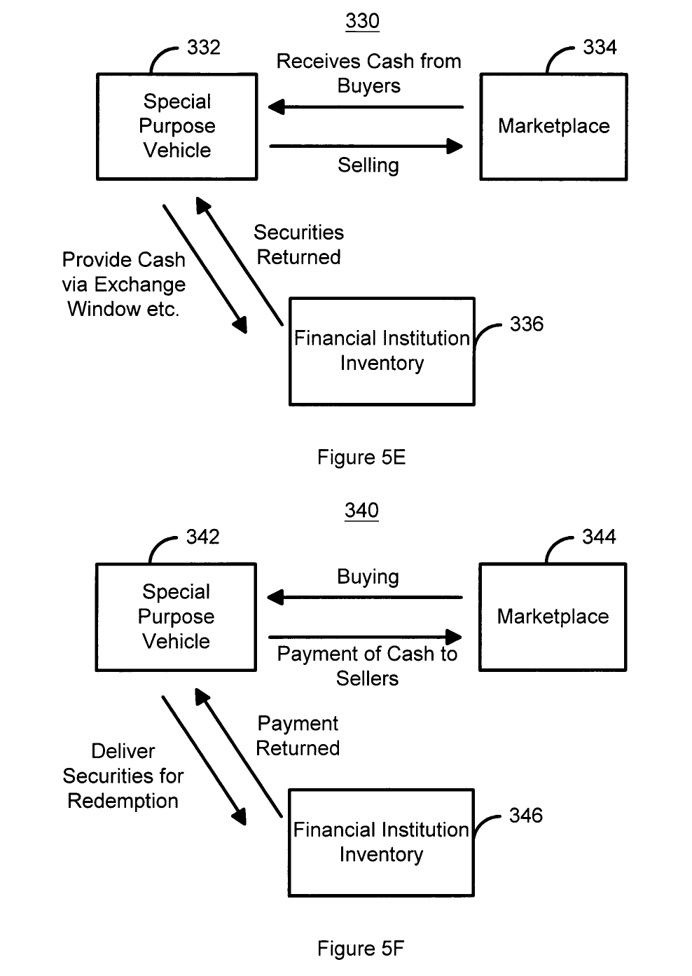

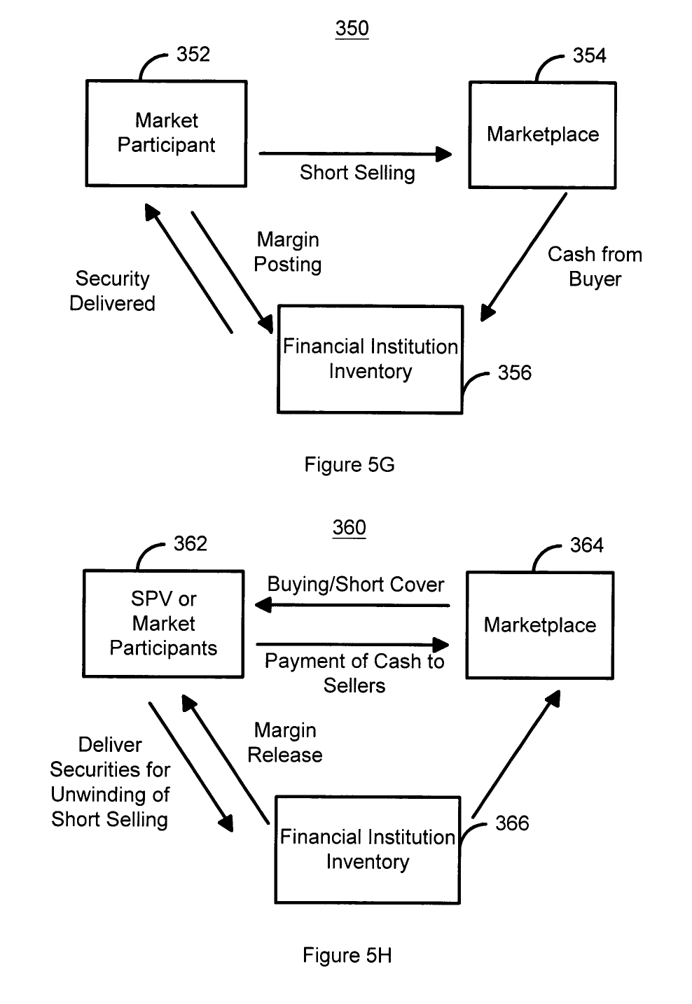

FIG. 5A is a flow chart depicting one embodiment of a method 180 in accordance with the present invention for utilizing financial institutions as guarantors of contract sets in accordance with the present invention. The SPV defined above is provided in step 182. Step 182 is analogous to step 101. In other words, the SPV described herein is provided in step 182. A financial institution is allowed to act as a guarantor for one or more contracts within a complete set and/or for one or more complete sets, via step 184. Step 184 could include utilizing a financial institution, such as a bank, to act as a custodian for monies used in trades. Step 184 could also include using the financial institution to provide collateralized financing for trades made. Step 184 could also include allowing the financial institution to issue securities that correspond to the complete set(s) of contracts. Thus, the trusted financial institution is used to facilitate transactions in the marketplace. As a result, it is believed that market participants will be more likely to engage in transactions. Liquidity is thereby improved.

FIGS. 5B-5H depict block diagrams of embodiments of SPVs in accordance with the present invention that interact with market participants and financial institutions in transactions using the method 180. FIG. 5B depicts one such system 300 providing collateralized financing when the SPV sells contract(s). The system includes an SPV 302, a marketplace 304, a system for managing the transactions such as an exchange 308 and a financial institution 306. The SPV 302 short sells individual contracts, preferably all of the contracts in a complete set, via the marketplace 304. In a preferred embodiment, the sum of prices of the contracts in the complete set is greater than or equal to the settlement value. The SPV 302 then receives cash from buyers via the marketplace 304. The SPV 302 then deposits the settlement amount, or other value, for the contracts sold with the financial institution 306. In an alternate embodiment, the buyers can deposit cash directly into the financial institution 306 without going through the SPV 302. The deposit provided by the SPV 302 is pledged, via the system 308, to the sellers to meet the margin requirements for a short sale. The complete set of contracts is then delivered to the buyers (who bought from the SPV 302) based upon the collateral provided by the financial institution 306.

FIG. 5C depicts one such system 310 providing collateralized financing when the SPV buys contract(s). The system includes an SPV 312, a marketplace or system 314, a financial institution 316, a system or exchange 318, and short sellers 319. The SPV 312 buys the individual contracts, preferably a complete set of contracts, via the marketplace 314. In a preferred embodiment, the sum of the prices of the contracts is less than or equal to the settlement value. The SPV 312 then pledges the contracts in the set to borrow money used in buying the contracts. The seller(s) through the Marketplace 314 are either long seller(s) or short seller(s), or both. The former would have monies deposited into the System 318 already, which are in turn deposited into Financial Institution 316. Such deposit would be unwound. For the latter, the short-seller(s) are required to put down short selling margin to the System 318. In either case (or in both cases), monies will be flowed to the System 318 which can be “recycled” by lending to SPV 312. Therefore, money from a short selling margin or from the financial institution 316 is provided to the system 318. The system 318 then lends the SPV 312 cash for the buy, based upon the collateral (contracts) provided by the SPV 312. The SPV 312 then pays the sellers the cash, via the marketplace 314. Note for the above processes (so as the following processes), exchange window may not be required. Also note that given the arrangement of collateralized financing, the SPV 312 may need minimal and in some cases even zero financial capital on a net basis (e.g. net cash flow equal to or greater than zero) to perform trades. In other words, with collateralized financing, the SPV 312 may enjoy similar or same financial benefit as if there were exchange window. Furthermore, if all trades/cash flows can be executed simultaneously and on net basis (net, direct and assigning payments, meaning “A pays B” and “B pays C” are simplified to “A pays C”), the SPV execute the processes described even without financial working capital. Therefore SPV will be operating not only with zero net capital but also with zero capital.

FIG. 5D depicts a simplified system 320 indicating the use of securities in transactions carried out via the method 180. The system 320 includes a financial institution 322 that builds up an inventory pool 324 of contracts sets and corresponding securities. The financial institution 322 issues complete sets of securities that are intended to replace or represent the contract sets. The securities are based upon the contracts in the inventory pool 324. The financial institution 324 can buyback the issues securities to unwind transactions. As will see later, the buyback and issuance is similar to the function of exchange window, with added benefit that market participants dealing with financial institution would have better confidence on the financial backing of the contracts (credit enhancement).

FIG. 5E is a more detailed block diagram of a system 330 that can use the financial institution as a guarantor and/or issuer through the use of securities. The system 330 includes a SPV 332, a marketplace 334, and a financial institution's inventory 336 of securities/contracts. The SPV 332 short sells individual contracts or securities in the complete set. In a preferred embodiment, the sum of the prices of the contracts is greater than or equal to the settlement value. The SPV 332 does receive cash from buyers (not explicitly shown) via the marketplace 334. The SPV 332 can exchange the cash, for example at an exchange window or other mechanism for exchanging the complete set, for the securities corresponding to the complete set of contracts. Thus, the SPV 332 receives the securities from the inventory 336. The SPV 332 can then use the securities for delivery to the buyers to complete the sale.

FIG. 5F is a more detailed block diagram of a system 340 that can use the financial institution as a guarantor and/or issuer through the use of securities. The system 340 includes a SPV 342, a marketplace 344, and a financial institution's inventory 346 of securities/contracts. The SPV 342 buys individual contracts or securities in the complete set via the marketplace 344. In a preferred embodiment, the sum of the prices of the contracts is less than or equal to the settlement value. The buyers, however, can deliver the set of securities in lieu of the complete set of contracts. The SPV 342 exchanges the security set, for example at an exchange window or other mechanism for exchanging the complete set, for cash. Thus, the SPV 342 receives cash from the inventory 346. The SPV 342 can then pay the sellers of the complete set of contracts or securities.

FIG. 5G is a more detailed block diagram of a system 350 that can use the financial institution as a guarantor and/or issuer through the use of securities. The system 350 includes a market participant 352, a marketplace 354, and a financial institution's inventory 356 of securities/contracts. The market participant 352 short sells one or more of the securities corresponding to contracts in the complete set via the marketplace 354. Cash from the buyer (not shown) can be provided to the inventory 356. In addition, the market participant 352 posts a margin with the inventory 356. Thus, a total that is the settlement value for the complete set of contracts is provided to the inventory 356. The security is then delivered to the market participant 352 for settlement with buyers (not shown). Thus, the market participant 352 can short sell and enjoy securitization.

FIG. 5H is a more detailed block diagram of a system 360 that can use the financial institution as a guarantor and/or issuer through the use of securities. The system 360 includes a market participant or SPV 362, a marketplace 364, and a financial institution's inventory 366 of securities/contracts. The market participant or SPV 362 buys one or more of the securities corresponding to contracts in the complete set via the marketplace 364. In this case, the market participant is short covering. The securities bought from the market participant or SPV 362 are delivered to the inventory 366, which releases the settlement value or, for less than the complete set, other value. The amount released by the inventory 366 releases the margin previously paid by the market participant or SPV 362 and pays for the buy price of the securities. Thus, the market participant or SPV 362 can perform a short cover.

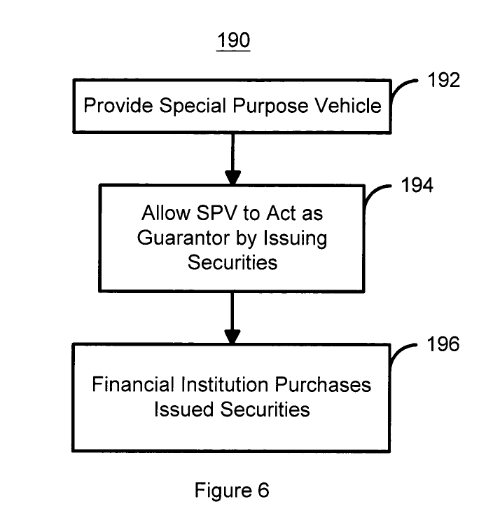

FIG. 6 is a detailed flow chart of one embodiment of a method 190 in accordance with the present invention for utilizing the special purpose vehicle to provide securities for transactions involving contracts in the complete set. The SPV defined above is provided in step 192. Step 192 is analogous to step 101. In other words, the SPV described herein is provided in step 192. The SPV is allowed to issue, independent of a financial institution, sets of securities that replace the contracts in complete sets, via step 194. Thus, the securities are analogous to those issued in step 184 of the method 180. However, these securities may not be backed by a financial institution. An inventory of the securities is thus provided. The securities can then be used as payment for deposits, collateral, or other transactions. In a preferred embodiment, market participants holding the securities would have priority over the SPV in claiming the collateral. Furthermore, a financial institution may buy all of the issued securities, via step 196. As a result, the financial institution, such as a bank, could still effectively act as a guarantor for the securities. Thus, more certainty could be provided to market participants even though the issuer of the securities is the SPV.

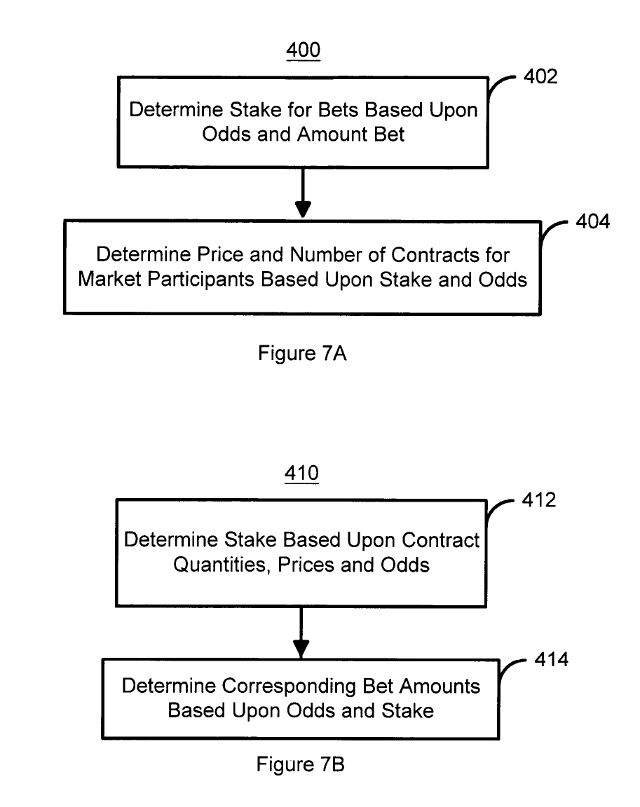

In addition, in accordance with the method and system described herein, different type of contracts, or orders, can be converted to a complete set of contracts. FIG. 7A depicts a high level flow chart of one embodiment of a method 400 in accordance with the present invention for converting other contracts into a complete set. The complete set of contracts is described above. For clarity, the method 400 is described in the context of betting. However, in an alternate embodiment, other financial instruments could be similarly converted. The bookmaker sets the odds prior to the method 400 commencing. Thus, it is assumed that the odds are known when the bets are converted to a complete set of contracts. In addition, it is assumed that the different outcomes are also known. Thus, a complete set would include each of the outcomes. For example, a complete set is to be formed for a horse race having five horses and the bets are on which horse wins, a complete set would include a bet to win on each of the five horses.

The total stakes for particular bets are determined based on the odds, via step 402. As described above, each bet is for a particular outcome, or contract in the complete set. In the example described above, assume that the odds are 5:1 for a particular horse and that a market participant has bet one dollar. Consequently, the stake is five dollars. The stake is the value of the contract(s) if the contract(s) held by the market participant are the winning contract. A number of contracts in the complete set and price per contract are determined for the bets based upon the stake, via step 404. Step 404 includes determining the value per contract if the contract wins, the corresponding number of contracts, and the price of the contract. The value per contract multiplied by the number of contracts held by the market participant equals the stake. In addition, the price is given by the value per contract divided by the odds. In the example above, the stake is five dollars. The exchange could decide that the contracts in the complete set are defined such that the value is one dollar per winning contract. Thus, step 404 would include dividing five dollars by one dollar per contract to give the number of contracts as five. The price per contract would be one dollar (value per contract) divided by the 5:1 (odds) for a price of twenty cents. Thus, using the method 400, bets can be converted into a complete set of contracts. One or more of the benefits of the method and system described herein can thus be achieved.

FIG. 7B depicts a high level flow chart of one embodiment of a method 410 in accordance with the present invention for converting contract orders into other financial instruments. Using the method 410, contract orders can be converted into the bet and odds format using the contract price and quantity. Thus, the method 410 can be viewed as the inverse of the method 400. The contracts are converted into a stake using the quantity and price, via step 412. Step 412 includes multiplying the number of contracts by their price and odds selected by the exchange or other organizer in order to obtain a stake. The stake is then converted into a bet and odds format using the odds, via step 414. Thus, the contracts in a complete set can be presented in a bet-odds format.

Consequently, using the methods 400 and 410, contracts in a complete set can be converted to a bet-odds format and vice versa. Information can thus be presented to market participants in either format (or both). Orders from both contract and bet formats can be combined and consolidated into one marketplace for presentation and trading. The present application is also related to co-pending U.S. patent application Ser. No. ______ (2701P), entitled “METHOD AND SYSTEM FOR MANAGING CREIDT-RELATED AND EXCHANGE RELATED RISKS” filed on ______. In this co-pending application (second co-pending application), a method and system for managing risks across systems having a risk differential is disclosed. For example, the systems could include those using a different currency, where the risk is expressed as an exchange rate, or systems having different credit ratings. The second co-pending application also uses the complete set of contracts defined above. Rate differentials, which result in hedging costs, exist between the systems. In one aspect, the method and system described in the second co-pending application include determining whether a matching trade for the contract is possible in a second system of the plurality of systems. In this aspect, the method and system described in the second co-pending application also include determining whether conducting a portion of the trade and a portion of the matching trade is profitable and, if so, performing the portion of the trade and the portion of the matching trade. In another aspect, the method and system described in the second co-pending application include determining whether it is profitable to individually sell the contract and a portion of the plurality of contracts. The portion of the plurality of contracts corresponding to at least one bid, if any. The at least one bid is in at least a second system corresponding to at least one rate differential between the first system and the at least the second system. The at least one rate differential results in the at least one hedging cost between the first system and the at least the second system. In this aspect, the method and system also include obtaining the complete set of contracts, if profitable, and individually selling the contract and the portion of the plurality of contracts, if profitable. In another aspect, the method and system include determining whether individually buying the contract at the particular price and a remaining portion of the plurality of contracts is profitable. At least one offer exists in at least a second system. Thus, at least one rate differential exists between the first system and the at least the second system. The rate differential results in the at least one hedging cost between the first system and the at least the second system. In this aspect, the method and system also include assembling the complete set by buying the contract and the remaining portion of the plurality of contracts, if required or profitable. In this aspect, the method and system also include exchanging the complete set for the settlement value, if profitable.

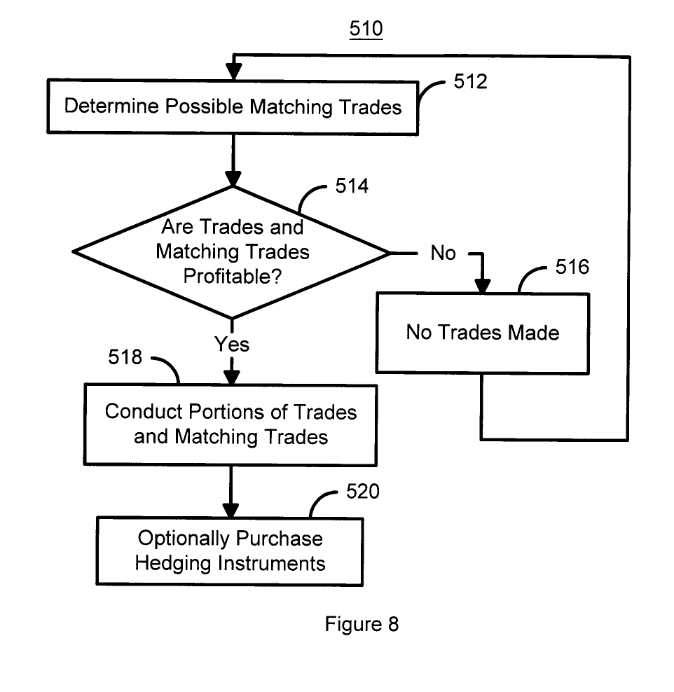

FIG. 8 is a high level flow chart of one embodiment of a method 510 in accordance with the present invention for managing risks by matching transactions. The method 510 is preferably implemented by the SPV 200 and/or by the server 105. The method 510 preferably operates on contracts within the complete set of contracts described above and in the above-identified co-pending patent applications. Consequently, the complete set of contracts can be exchanged for the settlement value regardless of whether any of the contracts actually matures. Thus, even if none of the contracts is deemed a winner, the complete set can be exchanged for the settlement value, at least for a particular amount of time. The winning contracts also guarantees a value, termed a notional, upon maturing. In one embodiment, the notional is equal to the initial settlement value (the settlement value prior to the interest rate being accounted for). In a preferred embodiment, the notional is equal to the settlement value. For clarity, the method 510 is described in the context of the SPV 200. However, the method 510 is fully applicable other systems and other SPVs.

Referring to FIG. 8, at the commencement of the method 510, one or more of the contracts in the complete set is offered for trade in one or more of the systems. A quantity, which may be greater than or equal to one unit, of the contract is offered for trade. The trade being offered could be a bid to buy or an offer for sale. It is determined whether matching trades in other systems are possible, via step 512. In a preferred embodiment, step 512 includes determining whether appropriate quantities of the matching trades are possible. If the contract offered for trade is initially an offer for sale, then the matching trade would be a bid to buy the contract. If the trade is a bid to buy, then the matching trade is an offer to sell. For example, if the first system is the NYSE and the trade is an offer to sell a quantity of the USD contract at a particular price in dollars, then the matching trade might be a bid to buy another quantity of the Yen contract for yen on the TSE. The other systems have a rate differential, such as due to the exchange rate or a credit risk, associated with them. Because of the rate differential, there are hedging costs associated with the matching trades if the rate differential is to be managed. In a preferred embodiment, the hedging cost is based upon the notional or the settlement value. In the example above, the rate differential is the exchange rate. The hedging cost is, therefore, the cost of buying a yen/dollar option for the notional or settlement value.

It is determined whether conducting one or more of the matching trades, or a portion of the matching trades will be profitable, via step 514. As used herein, trades can be profitable when the revenue gained from the trades is negative. For example, some positive profit may be believed to be achievable in the long term even when the matching trade(s) have a negative profit. Similarly, the organizer of the SPV 200 might obtain revenue from trades being made. Thus, the revenue from the matching trade(s) plus the revenue from trades being made might be positive. In general, as used herein trade(s) are considered to profitable if the profit (e.g. revenue minus cost from the trade(s)) is not less than a particular number that can be negative. In a preferred embodiment, step 514 determines whether a profit from making a portion of the trade and a portion of the matching trade(s) is greater than or equal to the hedging cost. In such a case, the profit would be greater than or equal to zero. However, because the SPV 200 may be run by an exchange that makes profits on any transaction, in an alternate embodiment step 514 determines whether the profit is greater than or equal to the hedging cost minus a particular amount. In a preferred embodiment, the trade and the matching trade(s) have corresponding quantities. For example, if the trade is a bid for two contracts in a first system, the matching trade(s) would be for sufficient contracts in other system(s) to fill the two contracts in the first system. However, in an alternate embodiment only a portion of the trade and/or only a portion of matching trade may be conducted. In other words, less than the quantity in the trade and/or less than the quantity of contracts in the matching trade may be traded. Only portions of transactions (less than the full quantity) may be carried out because it may take time to wait for sufficient bids and/or offers to occur to actually perform the transactions. Thus, in some instances, less than the full quantities of the trade and/or the matching trade may be utilized.

The hedging cost is also preferably determined in step 514. The hedging cost is based upon the risk to which the SPV 100 is exposed. In one embodiment, the hedging cost is based on the notional, which is the payment made on the winning contract. In another embodiment, the hedging cost is based upon the settlement value, which is what the SPV would pay to receive the complete set (including the contract being traded). In a preferred embodiment, the constant total sum and/or settlement value of a complete set limits the maximum amount of risk per contract and/or per complete set for trading across systems. Therefore, maximum hedging cost required can be determined and matching trades made possible with the risk under control.

If it is determined that making the portion of the trade the portion of the matching trade is not profitable, then the SPV 200 simply waits, via step 516. However, if it is determined that conducting the portion of the trade and the portion of the matching trade is profitable, then these trades are conducted, via step 518. In a preferred embodiment, the SPV 200 is allowed to lock in trades substantially simultaneously. Thus, the risk that the SPV would make the trade and not be able to make the matching trade because another market participant had done so, or vice versa, would be reduced. The hedging instrument is also optionally bought via step 520.

Thus, the SPV 200 can make profitable trades based upon rate differentials, such as credit ratings or exchange rates. The profit of the exchange or other entity controlling the SPV 200 can, therefore, be increased. Furthermore, without the SPV 200 performing the portion of the trade and matching trade(s), these transactions may not be conducted. Consequently, using the method 510, liquidity can be improved.

For example, suppose that a complete set of contracts includes contracts C1, C2 and C3. Upon maturity, assume that at most one of C1, C2 and C3 will pay one hundred units of respective currency—USD, yen or won depending on the system the contracts belong to. Furthermore, assume that the settlement value is also $100. In a first system, the NYSE, suppose that a bid to buy the contract C1 for $40 exists. Assume that two offers to sell the contract C1 at thirty-eight (38) yen exist on the TSE. The first offer is for one hundred (100) units of C1 and the second offer is for twenty-five (25) units of C1. In addition, a bid to buy the contract C1 at twenty-seven (27) won on a third system, a Korean exchange, exists. Also assume that the exchange rates are one hundred and twenty-five (125) yen per dollar and one thousand two hundred thirty (1230) won per dollar at a certain time. The SPV 200 could use the offers on the TSE or the bid in either the NYSE or Korea in order to perform the method 510. Suppose that the SPV 100 uses the bid on the NYSE. The SPV would locate the offers on the TSE as possible matches in step 112. The amount of profit, P, is given by:

P=Q_{A}*P_{A}−Q_{B}*P_{B}/R

where

P=Profit

Q_{A}=Quantity on System A

P_{A}=Price of Contract on System A

Q_{B}=Quantity on System B

P_{B}=Price of Contract on System B

R=Exchange rate between System A and System B

In addition, note that the quantity contracts bought accounts for the exchange rate. For exchange rates having a decimal place (e.g. 125.47), either the quantity is large enough (e.g. 100 to 12,547), or the nearest integer is used for the quantity (and strike of option used as a hedging instrument follows accordingly). Moreover, note that for examples described, the contract holders assume that no interest income is received for the money “spent” on buying contracts. For a system that pays interest to money put in, forward exchange rate is preferably considered and forward foreign exchange transaction is preferably performed. In addition, the interest cost for the hedging cost is preferably considered because such a cost would generally be paid upfront. Thus, the SPV 200 would use both of the offers on the TSE to determine the profit in step 514. If a different situation exists, for example offers for greater than one hundred twenty-five units of C1 existed on the TSE, then the SPV 200 would only make a portion of the matching trades to match the bid for a single C1 on the NYSE. Conversely, if the bids on the NYSE were for two contracts C1, then the SPV would not use all of the bids (would make only a portion of the trade). Based on the prices and exchange rates, in the example above, the SPV 200 would determine the profit to be $2. Such an amount is determined by the expected income from short-selling one lot of USD contracts of C1 at a price of US$40, minus the money needed to buy one hundred twenty-five lots of Yen contracts at thirty-eight yen each. The price of the Yen contracts translates to US$38 (125×38/125). The income is thus given by US$40 minus US$38, which equates to US$2. However, the SPV 200 would also determine the hedging cost. The SPV 200 could use either to determine the hedging cost. Because C1 is part of a complete set, the notional (what the SPV 200 would have to pay out) or the settlement value (the cost of buying a complete set including C1) could be used to determine the hedging cost. The notional, the amount paid to a holder of C1 if C1 wins, is $100. In addition, the settlement value-what the SPV 200 would have to pay to obtain a complete set (including C1)-is $100. In either case, the hedging cost would be the cost of a dollar call/yen put at a strike price of one hundred and twenty-five yen for an amount of one hundred dollars (such US$100 is the amount of the hedging instrument to buy). Thus, the holder of the hedging instrument would have the right, but not obligation to receive one hundred dollars for surrendering yen at the exchange rate of one hundred and twenty-five yen per dollar. In step 514, the SPV 200 would preferably determine whether this hedging cost is less than or equal to $2. If so, the SPV 200 would make the trade and the matching trade in step 518. In step 520, the SPV would also buy the dollar call/yen put described above.

Moreover, profits from more than one matching trades can be combined to help pay up for the hedging cost. Suppose that for the above example the hedging instrument costs $3, which is more than the $2 profit from the matching trade on C1. If the system can find a matching trade on contracts from the same set other than C1, say, C2 with a profit of $1 or more, the combined profit will be sufficient to meet the hedging cost. The two matching trades on C1 and C2 can be done together with only one hedging instrument only as needed. This is because the maximum risk of C1 and C2 combined, following the nature of a contract set, will be equal to or less than settlement value.

Note that the hedging instrument will have a definite expiry date and has a cost to extend beyond that date. Therefore, the contract set preferably has a well-defined expected maturity date, on or before which the outcome and payout to contracts would be determined. The terms and conditions of contracts preferably also allow for settlement in case of delay (termination settlement). In general, the outcome is not decided yet due to delay and the initial settlement value will be distributed to contracts in a pre-determined way, following the rule of constant total sum to the complete set. Therefore, contract holders know beforehand of such termination settlement arrangement and SPV 200 need not bear the unknown cost of involuntarily extending the life of hedging instrument to carry the matching trades.

Similarly, suppose a bid for C1 at $40 exists on one system and an offer to sell C1 at $38 exists on a second system, the SPV 200 would calculate a profit of $2 upon making the trade (both long and short C1 of different systems) in step 514. If C1 pays out, upon maturity, the SPV 200 expects to receive $100 from the seller on the second system and pays $100 to the buyer on the first system. Consequently, the SPV 200 is at risk of the seller of C1 (or, actually the system of the seller C1) not honoring the contract. The SPV 200 can account for this risk through a hedging instrument having a hedging cost. In this example, the hedging instrument might be a letter of credit, credit derivatives or other guarantee. The hedging instrument would be based upon the notional or the settlement value as described above. The SPV 200 would also determine the cost of the hedging instrument in step 514 and whether the cost is less than the $2 profit. The SPV 200 would carry out the transactions on the first system and the second system in step 518 and buy the hedging instrument in step 520.

Thus, the SPV 200 can determine whether a profit is to be made by transactions between systems having a rate differential. The SPV 200 can perform the transactions when profitable. Thus, the profit of the entity utilizing the SPV 200 can be increased. In addition, because trades that might not otherwise made are conducted by the SPV 200, liquidity is improved.

Furthermore, hedging costs can be reduced for other contracts in the complete set using the method 510. Once step 520 of the 510 is performed, the SPV 200 has a hedging instrument for a risk differential between a first system and a second system, such as the NYSE and the TSE in the above example. Because the contracts are all part of a complete set, the hedging instrument may be “used” again to buy any of the remaining the contracts in the same set (i.e. except C1). Thus, once the hedging instrument has been bought for one contract in the complete set, the hedging instrument can also be used for any other contract in the complete set. The complete set, therefore, allows the hedging cost to be shared between contracts in the complete set. In the exchange rate example above, if a bid for C2 and/or C3 on the NYSE appears and the exchange rate is unchanged, the SPV 200 can obtain matching trades on the TSE without buying another hedging instrument. If the exchange rate has changed, then the SVP 200 need only account for the difference in the exchange rates since the buy of the hedging instrument.

If no further hedging instrument is bought, matching trades may be done with quantities of contracts following the ratio implied by option's strike (rather than the new or current exchange rate). The matching trade is by itself a break even or better trade as measured by P>=0 for P=QA*PA−QB*PB/R, R being the current exchange rate, and QA and QB follow the ratio implied by the FX option's strike. Thus, step 114, determining whether making trades and matching trades is profitable is simplified by the reduced (or zero) hedging cost. If contracts corresponding to more than one complete set are held by the SPV 200, then more than one hedging instrument is bought. For example, if a complete set is two Cₐ, one C_{b} and three C_{c}, then more then one hedging instrument is bought if the SPV 100 holds more than two Cₐ, more than one C_{b}, and/or more than three C_{c}. Consequently, in addition to accounting for the rate differential, the method 510 allows for potential sharing and therefore reduction in hedging costs.

Furthermore, hedging instruments can be combined to provide new trading opportunities. For example, a matching trade is done on long yen contract/short USD contract on C1. Another matching trade is done on long USD contract/short won contract on C2. In fact, by sharing two hedging instruments arisen from the two matching trades, a matching trade may be done on C3 for long yen contract/short won contract without additional hedging instrument needed. It is because the first hedging instrument will allow for matching trade of long yen contract/short USD contract on C2 or C3, which the second will allow for long USD contract/short won contract on C1 and C3. Combining the two for common contract C3 will lead to possible trade on long yen contract/short won contract for C3.

Furthermore, hedging instruments can be partially or completely recycled. The SPV 200 may choose to unwind transactions having a risk due to a rate differential. For example, SPV 200 may wait for a particular market situation to unwind matching trades (opposite to matching trade). If after a matching trade the SPV 100 is long one hundred twenty five units of yen contracts of C1 and short one unit of USD contracts of C1, the SPV 200 can sell the long yen contract and short-cover/buy the short USD contract simultaneously if and when such trades are profitable. Such unwinding will not require hedging instrument and in fact would release the hedging instrument after unwinding. For further example, the hedging instrument has a market value, and such market value will help to unwind the matching trade. Suppose the hedging instrument, which is initially bought at US$2, is now worth US$3 due to changes in market conditions (e.g. changes in the exchange rate). If the SPV 200 checks the market and finds that the long yen contract can be sold and the short USD contract can be short-covered/bought simultaneously at a loss of US$3 or less, the SPV 200 can proceed with the unwinding as the loss can be subsidized by the income from selling out the hedging instrument at US$3. In another example, the SPV 200 may exchange a complete set for the settlement value or vice versa. For example, suppose the SPV 200 is now short a complete set of USD contracts and long a complete set of Yen contracts. The SPV 200 will be short USD$100 of cash and long 12,500 yen after converting the contract positions into settlement values. If the current exchange rate of USD/Yen is above 125 (which is the strike of the option bought as a hedging instrument and the exchange rate when the initial round of matching trade(s) was done), the long yen cash would be insufficient to offset for the short USD cash (this explains why hedging instrument is needed for the matching trades). The hedging instrument, the option, could then be sold to pay for the difference (the value of option is high enough to pay for it). However, if exchange rate moves favorably or stays such that current exchange rate of USD/Yen being one hundred and twenty-five or lower, the short US100 cash/long 12,500 yen position can be unwound without changing the option position. An extra profit maybe realized from unwinding the short US100 cash/long 12,500 yen position. Taking an extreme example, if USD/Yen exchange rate has moved from one hundred twenty-five to one hundred, the long yen cash of 12,500 yen will be exchanged into USD125. After repaying the short USD cash of USD100, there will be a positive balance of USD25 as extra profit. The SPV 200 could then still hold the hedging instrument for the risk differential between a first system and a second system. The SPV 200 may then find other trades in the first system and matching trades in the second system using the method 510. Because the SPV 200 still holds the hedging instrument, step 514 would be simplified in that the hedging cost would be zero (or reduced). Consequently, the SPV 200 could obtain additional profit using the method 510 and recycling the hedging instrument. Recycling may also mean simply selling the hedging instrument for cash. Such hedging instruments have a non-negative value as the hedging instruments provide a right but not an obligation to the holder. In the example above, suppose that the SPV 200 assembles one hundred and twenty five units of the complete set of contracts in the TSE, then exchanges the complete sets for the settlement amounts (therefore resulting in long cash in yen currency). The SPV 200 also exchanges the settlement amount in dollars for the complete set in the NYSE (therefore resulting in short cash in USD currency). The SPV might choose to make these exchanges because it is profitable to do so. The SPV 200 has thus unwound any shorting and longing of contracts in the NYSE and TSE. Upon favorable conditions such as current level of USD/Yen exchange rate, the SPV 200 may still use the hedging instrument bought in step 120 when performing the method 510 again. Thus, step 514 of determining profitability may be changed because the hedging cost may be reduced or eliminated. Similarly, the step 520 of buying the hedging instrument might be omitted. Thus, the hedging instrument is potentially recycled, either partially or completely.

A method and system has been disclosed for improving the liquidity of transactions. An SPV, which can buy or sell complete sets of contracts or portions of complete sets of contracts. The SPV can also generate conditional orders, including zero price bids. Furthermore, the credit risk for individual market participants can be defined. As a result, liquidity can be improved, and credit risk can be allocated. Software written according to the present invention is to be stored in some form of computer-readable medium, such as memory, CD-ROM or transmitted over a network, and executed by a processor. Consequently, a computer-readable medium is intended to include a computer readable signal which, for example, may be transmitted over a network. Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for improving liquidity of transactions for a plurality of contracts, the method comprising the steps of:
defining a complete set including the plurality of contracts, the complete set guaranteeing at least an initial settlement at at least one particular time, the complete set corresponding to a settlement value, the settlement value being determined based upon the initial settlement value; and
allowing at least one market participant to lock in a trade for a portion of the plurality of contracts, the portion of the plurality of contracts including multiple contracts.

2. A method for improving liquidity of transactions for a plurality of contracts, the method comprising the steps of:
providing a special purpose vehicle, the special purpose vehicle for buying and/or selling at least a portion of a complete set including the plurality of contracts, the complete set guaranteeing at least an initial settlement at at least one particular time, the complete set corresponding to a settlement value, the settlement value being determined based upon the initial settlement value.

3. The method of claim 2 wherein the settlement value is determined based upon the initial settlement value and an interest rate effect, if necessary, wherein the interest rate effect includes an adjustment in a present value based upon an interest rate, the initial settlement value, and a time between the at least one particular time and the settlement value being determined.

4. The method of claim 2 wherein each of the plurality of contracts matures upon at least one particular event occurring and wherein the complete set corresponds to at least the settlement value regardless of whether the at least one particular even occurs for any of the plurality of contracts.

5. The method of claim 2 wherein the at least one particular time corresponds to at least a portion of the plurality of contracts maturing.

6. The method of claim 2 further comprising the step of:
allowing the special purpose vehicle to assemble the complete set by buying at least the portion of the complete set based upon a sum of offers and the settlement value.

7. The method of claim 6 wherein the allowing step further includes the step of:
automatically buying the at least the portion of the complete set to assemble the complete set when a sum of offers for the complete set is less than or equal to the settlement value.

8. The method of claim 2 further comprising the step of:
allowing the special purpose vehicle to sell the at least the portion of the complete set based upon a sum of bids and the settlement value.

9. The method of claim 8 wherein the allowing step further includes the step of:
automatically selling the at least the portion of the complete set to at least one market participant using the special purpose vehicle when a sum of bids for the complete set is greater than the settlement value.

10. The method of claim 2 wherein the special purpose vehicle is allowed to secure trades when buying and/or selling at least one of the plurality of contracts.

11. The method of claim 2 wherein at least one bid to buy corresponds to at least one contract of the plurality of contracts, the method further comprising the step of:
generating a conditional order to sell a remaining portion of the complete set, the conditional order to sell being based upon the at least one bid, the conditional order having a corresponding condition, the corresponding condition being the at least one bid and the conditional order to sell both being accepted, the special purpose vehicle making at least one trade of the remaining portion of the complete set when the condition is fulfilled.

12. The method of claim 11 wherein a sum of the at least one bid and a total of at least one price for each of the remaining contracts is less than or equal to the settlement value.

13. The method of claim of 11 wherein the generating step further includes the step of:
generating a zero price bid to provide the at least one bid.

14. The method of claim 2 wherein at least one offer to sell corresponds to at least one contract of the plurality of contracts, method further comprising the step of:
generating a conditional order to buy a remaining portion of the complete set, the conditional order to buy being based upon the at least one offer, the conditional order having a corresponding condition, the corresponding condition being the at least one offer and the conditional order both being accepted, the special purpose vehicle making at least one trade of the remaining portion of the complete set when the condition is fulfilled.

15. The method of claim 14 wherein a sum of the at least one offer and a total of at least one price for each of the remaining contracts is greater than or equal to the settlement value.

16. The method of claim 2 wherein at least the special purpose vehicle providing step is provided using a computer system.

17. The method of claim 2 wherein a plurality of market participants correspond to at least a portion of the plurality of contracts, the method further comprising the step of:
determining a credit risk for each of the plurality of market participants based upon the settlement value and a selling price for each of the plurality of contracts.

18. The method of claim 17 wherein a portion of the plurality of market participants are short selling a first portion of the plurality of contracts, and wherein the credit risk determining step further includes the steps of:
determining the credit risk for each of the portion of the plurality of market participants based upon the selling price of each of the first portion of the plurality of contracts and a winning payout for the contract.

19. The method of claim 17 wherein the credit risk is the winning payout minus the selling price.

20. The method of claim 19 wherein an exchange acts as a custodian for a short margin for each of the plurality of market participants, the short margin being based upon the credit risk.

21. The method of claim 19 wherein a bank acts as a custodian for a short margin for each of the plurality of market participants, the short margin being based upon the credit risk.

22. The method of claim 19 wherein the special purpose vehicle acts as a custodian for a short margin for each of the plurality of market participants, the short margin being based upon the credit risk.

23. The method of claim 22 wherein the special purpose vehicle places the short margin in an interest bearing account.

24. The method of claim 18 further comprising the step of:
allowing a market participant to define a credit risk matrix, the credit risk matrix indicating a first portion of the plurality of market participants and an allowed credit risk for each of the first portion of the plurality of market participants, the allowed credit risk indicating the market participant's maximum desired exposure for each of the first portion of the plurality of market participants.

25. The method of claim 24 further comprising the step of:
allowing the market participant to define a second credit risk matrix, the second credit risk matrix indicating a second portion of the plurality of market participants and a second allowed credit risk for each of the second portion of the plurality of market participants, the second allowed credit risk indicating the market participant's maximum desired exposure for each of the second portion of the plurality of market participants.

26. The method of claim 25 wherein to of the first portion of the plurality of market participants can attain credit netting through the market participant.

27. The method of claim 25 wherein to of the first portion of the plurality of market participants can attain credit swapping through the market participant.

28. The method of claim 25 wherein to of the first portion of the plurality of market participants can attain credit bridging through the market participant.

29. The method of claim 2 further comprising the step of:
allowing a financial institution to provide collateralized financing for the special purpose vehicle.

30. The method of claim 29 wherein the financial institution allowing step further includes the steps of:
allowing the special purpose vehicle to short sell the complete set to a buyer;
the special purpose vehicle depositing the settlement value to the financial institution; and
using the financial institution to obtain the complete set.

31. The method of claim 30 wherein the financial institution using step further includes the steps of:
allowing the financial institution to provide the settlement value to meet a margin requirement; and
delivering the complete set to the buyer.

32. The method of claim 29 wherein the financial institution allowing step further includes the steps of:
using the special purpose vehicle to buy the complete set from a seller;
using the financial institution to provide a loan to the special purpose vehicle, the loan being for at least a portion of the settlement value, the complete set being used as collateral for the loan.

33. The method of claim 2 further comprising the step of:
allowing a financial institution to act as a guarantor for the settlement value and/or the complete set of contracts.

34. The method of claim 33 wherein the financial institution allowing step further includes the step of:
issuing a set of securities by the financial institution, the set of securities corresponding to the complete set of contracts and/or the settlement value.

35. The method of claim 34 wherein the financial institution allowing step further includes the step of:
allowing the special purpose vehicle to deliver the set of securities to a buyer of the complete set in lieu of the complete set.

36. The method of claim 34 wherein the financial institution allowing step further includes the step of:
allowing the special purpose vehicle to receive cash in exchange for the set of securities; and
using the cash to pay a seller of the complete set.

37. The method of claim 34 wherein the financial institution allowing step further includes the step of:
allowing a market participant to utilize the set of securities in transactions relating to the complete set.

38. The method of claim 2 further comprising the step of:
using the special purpose vehicle to issue a set of securities, the set of securities corresponding to the complete set of contracts and/or the settlement value.

39. The method of claim 38 wherein the special purpose vehicle using step further includes the step of:
allowing a financial institution to act as a guarantor of the set of securities.

40. The method of claim 39 wherein the financial institution guarantor allowing step further includes the step of:
allowing the financial institution to buy all of the set of securities.

41. The method of claim 2 further comprising the step of:
converting a plurality of bets from a bet-odds format to the plurality of contracts.

42. The method of claim 2 further comprising the step of:
converting the plurality of contracts to a bet-odds format.

43. A computer-readable medium containing a program for improving liquidity of transactions for a plurality of contracts, the program including instructions for:
defining a complete set including the plurality of contracts, the complete set guaranteeing at least an initial settlement at at least one particular time, the complete set corresponding to a settlement value, the settlement value being determined based upon the initial settlement value.
allowing at least one market participant to lock in a trade for a portion of the plurality of contracts, the portion of the plurality of contracts including multiple contracts.

44. A computer-readable medium containing a program for improving liquidity of transactions for a plurality of contracts, the program including instructions for:
providing a special purpose vehicle, the special purpose vehicle for buying and/or selling at least a portion of a complete set including the plurality of contracts, the complete set guaranteeing at least an initial settlement at at least one particular time, the complete set corresponding to a settlement value, the settlement value being determined based upon the initial settlement value.

45. The computer-readable medium of claim 44 wherein the settlement value is determined based upon the initial settlement value and an interest rate effect, if necessary, wherein the interest rate effect includes an adjustment in a present value based upon an interest rate, the initial settlement value, and a time between the at least one particular time and the settlement value being determined.

46. The computer-readable medium of claim 44 wherein the program further includes instructions:
allowing the special purpose vehicle to assemble the complete set by buying at least the portion of the complete set based upon a sum of offers and the settlement value.

47. The computer-readable medium of claim 44 wherein the allowing instructions further includes instructions:
allowing the special purpose vehicle to sell the at least the portion of the complete set based upon a sum of bids and the settlement value.

48. The computer-readable medium of claim 44 wherein the special purpose vehicle is allowed to secure trades when buying and/or selling at least one of the plurality of contracts.

49. The computer-readable medium of claim 44 wherein at least one bid to buy corresponds to at least one contract of the plurality of contracts, the program further including instructions for:
generating a conditional order to sell a remaining portion of the complete, the conditional order to sell being based upon the at least one bid, the conditional order having a corresponding condition, the corresponding condition being the at least one bid and the conditional order to sell both being accepted, the special purpose vehicle making at least one trade of the remaining portion of the complete set when the condition is fulfilled.

50. The computer-readable medium of claim 44 wherein the program further includes instructions for:
allowing a financial institution to provide collateralized financing for the special purpose vehicle.

51. A system for improving liquidity of transactions for a plurality of contracts, the system comprising:
a special purpose vehicle for buying and/or selling at least a portion of a complete set including the plurality of contracts, the complete set guaranteeing at least an initial settlement at at least one particular time, the complete set corresponding to a settlement value, the settlement value being determined based upon the initial settlement value.

52. The system of claim 51 wherein the settlement value is determined based upon the initial settlement value and an interest rate effect, if necessary, wherein the interest rate effect includes an adjustment in a present value based upon an interest rate, the initial settlement value, and a time between the at least one particular time and the settlement value being determined.

53. The system of claim 51 wherein the special purpose vehicle is also capable of assembling the complete set by buying at least the portion of the complete set based upon a sum of offers and the settlement value.

54. The system of claim 51 wherein the special purpose vehicle is also capable of selling the at least the portion of the complete set based upon a sum of bids and the settlement value.

55. A system for improving liquidity of transactions for a plurality of contracts comprising:
means for defining a complete set including the plurality of contracts, the complete set guaranteeing at least an initial settlement at at least one particular time, the complete set corresponding to a settlement value, the settlement value being determined based upon the initial settlement value; and
means for allowing at least one market participant to lock in a trade for a portion of the plurality of contracts, the portion of the plurality of contracts including multiple contracts.
